(19) United States
(12) Patent Application Publication
(10) Pub. No.: US 2019/0244127 A1
(43) Pub. Date: Aug. 8, 2019

(54) ADAPTIVE TEACHING SYSTEM FOR GENERATING GAMIFIED TRAINING CONTENT AND INTEGRATING MACHINE LEARNING

(71) Applicant: Progrentis Corp., Ciudad de Panama (PA)

(72) Inventors: Carlos Armando Amado, Guatemala (GT); Emilio Torres Gonzalez, Santa Cruz de Tenerife (ES)

(73) Assignee: Progrentis Corp., Ciudad de Panama (PA)

(21) Appl. No.: 16/271,461

(22) Filed: Feb. 8, 2019

Related U.S. Application Data
(60) Provisional application No. 62/627,819, filed on Feb. 8, 2018.
(60) Provisional application No. 62/668,613, filed on May 8, 2018.
(60) Provisional application No. 62/668,645, filed on May 8, 2018.

(51) Int. Cl. G06N 7/02; G06F 16/332; G09B 5/02; G09B 7/02; G06N 20/00; A63F 9/18; G06K 9/62

(52) U.S. Cl. CPC G06N 7/023; G06F 16/3329; G09B 5/02; G06K 9/6227; G06N 20/00; A63F 9/18; G09B 7/02

(57) ABSTRACT

An improved system and method for generating gamified training content using multimodal human-machine interfaces controlled by an adaptive backend training system. Such a system can include a gamification engine working in conjunction with a machine learning engine for adaptively updating or restructuring database elements by analyzing existing data and applying external training data. Training content can thus be progressively optimized for various users, groups, and training contexts as the system adapts.

### CROSS-REFERENCE TO RELATED APPLICATIONS

This patent application claims priority to U.S. Provisional Patent Application Ser. No. 62/627,819, filed on Feb. 8, 2018, titled “Streamlined skills learning through gamified PBL exercises”; U.S. Provisional Patent Application Ser. No. 62/668,613, filed on May 8, 2018, titled “Streamlined learning and training through partially gamified retrieval exercises”; and U.S. Provisional Patent Application Ser. No. 62/668,645, filed on May 8, 2018, titled “Adult learning and mental health recovery through retrieval exercises”; the entire disclosures of each of which is incorporated herein by reference in their entirety.

### BACKGROUND OF THE INVENTION

### Field of the Invention

The present invention relates generally to an improved human computer interface and backend system for generating content thereon. More particularly, the invention relates to a system including (a) one or more adaptive human computer interfaces that present gamified training content, and (b) the corresponding backend system (e.g. servers and databases) for intelligently generating the content. Even more particular, the invention relates to a system for adaptive automated teaching that generates gamified training content with integrated machine learning for adapting the human computer interface according to multimodal input received by the human machine interface.

### Description of the Related Art

Intelligent teaching systems stem from and are closely related to intelligent tutoring systems (ITS), and these have been defined to replace a human tutor by a machine or, to be, most frequently, computer based training (CBT). Intelligent Tutoring Systems (ITS) were popular in the seventies, to be mostly seen until the late eighties when expert systems were also popular. Research in ITS considers that problems should be organized as knowledge about (a) a domain and, (b) the learner, plus pedagogy, as the understanding of teaching strategies. This is why components of ITS frequently included an expert (or domain) model, a student model, and a tutoring model to submit the problem to the students.

After ITS were found to be too difficult to implement with limited results, some experts suggested that better solutions could be implemented through cognitive tools. [Derry & Lajoie, 1993. Computers as cognitive tools. Hillsdale, N.J.: Lawrence Erlbaum.] Cognitive tools may be interpreted as unintelligent tools, which rely on the learner, not the computer, to provide the intelligence. In this case, planning and decisions are in hands of the learner, not the technology. However, cognitive tools serve as powerful catalysts to connect or facilitate collaborative problem-solving.

Computer-based training systems (CBT), and Web-based training (WBT) systems are mostly forms of computer-based training that generally use a learning management system (LMS). It also is defined as e-instruction or web-based instruction or simply as e-learning. Differences between CBT and WBT include (1) CBT is not connected to a network, and (2) WBT also may include communications among different participants. Most forms of modern e-learning are inspired by this paradigm in the form of web-based training (WBT). An LCMS, or learning content management system, (sometimes also called “Course Management System”, “Pedagogical Platform”, “ELearning Platform”) is a software system that delivers courseware plus e-tutoring over the Internet, and it allows users to create and manage learning contents.

Within a learning environment, whether electronic or otherwise, the term or concept of “testing” can evoke a certain response from most: the person being tested is being evaluated on his or her knowledge or understanding of a particular area, and will be judged right or wrong, adequate or inadequate based on the performance given. This implicit definition does not reflect the settings in which the benefits of “test-enhanced learning” have been established. In experiments done in cognitive science laboratories, “testing” was simply a learning activity for the students; in the language of the classroom, it could be considered a “no-stakes” formative assessment where students could evaluate their memory of a particular subject. In most of the studies from classrooms, the “testing” was either no-stakes recall practice (Larsen et al. 2009; Lyle and Crawford, 2001; Stanger-Hall et al., 2011) or low-stakes quizzes (McDaniel et al., 2012; Orr and Foster, 2013). Thus, the term retrieval practice may be a more accurate description of the activity that promoted students' learning. Implementing approaches to test-enhanced learning in a class should, therefore, involve no-stakes or low-stakes scenarios in which students are engaged in a recall activity to promote their learning rather than being repeatedly subjected to high-stakes testing situations. The “testing” that actually enhances learning is the low-stakes retrieval practice that accompanies studying.

In essence, test-enhanced learning is the idea that the process of remembering concepts or facts—retrieving them from memory—increases long-term retention of those concepts or facts. This idea, also known as the testing effect, rests on myriad studies examining the ability of various types of “tests”—prompts to promote retrieval—to promote learning when compared to studying. It is one of the most consistent findings in cognitive psychology (Roediger and Butler 2011; Roediger and Pyc 2012). In some ways, the terms “test-enhanced learning” and the “testing effect” are misnomers, in that the use of the word “tests” calls up notions of high-stakes summative assessments. In fact, most or all studies elucidating the testing effect examine the impact of low-stakes retrieval practice on a delayed summative assessment. The “testing” that actually enhances learning is the low-stakes retrieval practice that accompanies study in these experiments.

With that caveat in mind, the testing effect can be a powerful tool to add to instructors' teaching toolkits—and students' learning toolkits. Incorporating frequent quizzes into a class's structure may promote student learning. These quizzes can consist of short-answer or multiple-choice questions and can be administered online or face-to-face. Studies investigating the testing effect suggest that providing students the opportunity for retrieval practice—and ideally, providing feedback for the responses—will increase learning of targeted as well as related material.

As shown, it has been documented in articles and publications by Scientific American, The New York Times, Science, Vanderbilt University, and many others, that test-enhanced learning through low stakes retrieval practical testing exercises beneficially alters the learning mind. And, some even argue that this mechanism allows the learning mind to enter into a metacognition state (thus, understanding how it learns), to automatically develop better learning mechanisms and better-practiced skills.

Gamification in learning as an approach to education intends to motivate students into learning through game elements in a learning environment. Its objectives are maximizing enjoyment and engagement, and capturing learners' interest, thus inspiring them for further learning.

Through sources such as Kapp, Karl, 2012, the Gamification of Learning and Instruction and Huang, Wendy Hsin-Yuan et al, 2013, University of Toronto, gamification may be defined as the process of defining the elements which comprise games that make those games fun and motivate players to continue playing, and using those same elements in a non-game context to influence behavior. In other words gamification is the introduction of game elements in a non-game situation.

Machine learning has been defined as a field within computer science that has evolved from the works of pattern recognition and computational learning theory in artificial intelligence. [www.britannica.com/EBchecked/topic/1116194/machine-learning]. And, in 1959, Arthur Samuel described machine learning as follows, a “field of study that gives computers the ability to learn without being explicitly programmed”. Tom M. Mitchell also defined the algorithms studied in machine learning: “A computer program is said to learn from experience E with respect to some class of tasks T and performance measure P if its performance at tasks in T, as measured by P, improves with experience E.” [Mitchell, T., 1997. Machine Learning. McGraw Hill.].

Machine learning tasks are classified into categories like supervised learning (such as Classification algorithms and regression algorithms), semi-supervised learning (from incomplete training data), or unsupervised learning (used to find structure or discover patterns in the data and grouping the inputs into categories). There are meta learning algorithms, robot learning algorithms, topic modeling, active learning algorithms, reinforcement learning algorithms (with feedback as positive or negative reinforcement, as in autonomous automobiles). A principal goal for a learner is to be able to generalize from experience. [Bishop, C. M., 2006. Pattern Recognition and Machine Learning, Springer.] Learning machines should execute with accuracy on new, formerly unknown cases or problems, after going through a learning data set, or because of training examples. Machine learning, its algorithms and performance, is studied as computational learning theory.

While digital learning systems are more effective in certain circumstances than manual human teaching techniques, current digital teaching and learning systems are not sufficiently powerful, engaging, versatile, intelligent, or adaptive to maximize the testing effect, particularly when dealing with certain individuals or groups that have difficulty with conventional modes of test taking.

Thus, there is a need for improved systems and methods for computerized learning that can capture at least some of the benefits of ITS, CBT, WBT, LMS, LCMS, etc. with greater effectiveness or with fewer drawbacks.

### SUMMARY OF THE INVENTION

In accordance with an aspect of the present disclosure, there is provided a structure, methodology and distributed execution system aided by integrated machine learning, to provide adaptive teaching resources through the generation of gamified training content and partially gamified retrieval exercises, via an improved human-machine interface autonomously, without a human intermediary instructor.

According to aspects of the present invention, an intelligent teaching system is capable of overcoming the drawbacks associated with conventional digital teaching systems (e.g. ITS, CBT, WBT, LMS, LCMS) through the use of gamification, database intelligence, adaptive feedback, and/or machine learning. According to one definition, “gamification” describes the use of game elements in non-game systems to improve or influence the user experience. An important consideration for applying gamification is identifying the appropriate time at which or extent to which game elements should be introduced to various individuals or groups engaged in various types of training content.

This adaptive problem-based learning system, may apply interactive, gamified, low stake tests, through knowledge content restructuring in retrieval practice exercises with immediate feedback. Gamified training content is generated and gradually improved after student interaction through aid of integrated machine learning engines and intelligence databases.

The system or various aspects thereof can operate as distributed software in information networks composed of different types of equipment, be it computers and other tools such as, for example, intelligent windows, boards, appliances, wearable computers and devices, positioning systems, smart home devices, connected vehicles, exoskeletons, drones, telepresence robots, or kinetic input/output devices.

Student/user responses may comprise simple answers, or follow-through actions imitating real-life situations, including risk-averse considerations typical of group collaboration and team building.

The invention adds the ability to simplify, automate and improve learning, by enriching gamified content experiences, through the aid of constantly updated learning cases information, application of machine learning algorithms, thus interpreting students' specific responses to bring immediate feedback to students through the invention's interactions engines.

This technology allows improved, streamlined, constantly adaptive learning through the aid of machine intelligence for all types of students where reading and understanding for the interpretation and analysis of information is paramount. It can also be tailored for immersive experiences for adult learning and habits-shaping, such as in the case of remedial education, and for psychological therapy-based intervention in the cases where specific therapy guidelines and manuals exist and are available.

In the case of psychological therapy-based intervention, targeted therapy approaches for the invention may include, among others, Cognitive Behavioral Therapy (CBT) and derivative therapies, Acceptance and Commitment Therapy (ACT), Dialectical Behavior Therapy (DBT), or Mode Deactivation Therapy (MDT).

Exemplary aspects, examples, implementations, and embodiments of the invention are discussed in detail below, along with their respective advantages. Examples disclosed herein may be combined with other examples in any manner consistent with at least one of the principles disclosed herein, and references to “an example,” “some examples,” “an alternate example,” “various examples,” “one example”, “implementations”, or the like are not necessarily mutually exclusive and are intended to indicate that a particular feature, structure, or characteristic described may be included in one or more examples or implementations. The appearances of such terms herein are not necessarily all referring to the same example or implementation. Various aspects, examples described herein may include means for performing any of the described methods or functions.

The present invention describes aspects and embodiments of an automated digital training system (the “system”) for use in applications such as remedial education, group learning, therapy training, medical treatment, institutional/group/organizational learning, reading improvement, student curriculum studies (particularly in knowledge matters where understanding and learning to put into practice is key). The training system is alternatively referred to as a learning, teaching, therapy, or treatment system herein. Training participants (users, subjects, etc.) can include students, executives, employees, patients, educators, developers, and other individuals or groups of individuals. The present system generates gamified training content and presents content to users via a gamified interface capable of portraying gamified representations of content. The use of gamified content can influence various cognitive and emotional aspects of training, which can ultimately influence learning effectiveness.

For example, the system can intelligently introduce one or more gamified elements to facilitate learning that is optimized for certain learning styles, or cognitive/emotional needs of each participant. Users interact with the gamified interface via one or more human-machine interfaces, including, but not limited to, personal computers, mobile devices, smartphones, tablets, displays, other electronic input devices, IoT devices, smart devices, virtual or augmented reality interfaces, motorized devices such as remotely controlled vehicles, game controllers such as wheels, pedals, sticks, balls, controllers, kinetic input/output devices, brain computer interface devices, or any combination thereof. The system is capable of adaptively progressing, or navigating, testing and interactive content, and presentation style, as a user progresses, or navigates, through content by, for example, associating input data received, which may include input from multiple disparate input devices, including multimedia content, with testing content, previous testing event data, diagnoses, and other data stores in one or more databases, such as relational databases.

Research has shown that effectiveness of conventional test taking using static text content can have severe shortcomings, especially when applied to certain users or groups (for example, in the context of remedial education or therapy training, where students/participants can be disengaged or difficult). The present invention makes use of various educational techniques and methodologies such as partial gamification and reward, problem based learning through retrieval exercises, teaching for multiple types of intelligence (e.g. emotional intelligence vs. conventional IQ), low-stakes restructuring, experiential learning, learning through understanding, simulation of real-life conditions/situations, targeted learning of certain skills, interactive learning, structural learning, etc.

One aspect of learning and cognition influenced by gamification is the concept of motivational affordances, which further relates to the concept of affordances from perceived opportunities for action to questions of motivation, linking up with need satisfaction theories of motivation, specifically Self Determination Theory (SDT). Need satisfaction theories argue that human beings seek out (and continue to engage in) activities if these promise (and succeed) to satisfy motivational needs, such as competence, autonomy, or relatedness.

In one example illustrating different learning styles, slow readers often read visually and orally with significant, frequently, or irregular eye movement, whereas fast readers often read only visually and with quick, deliberate scanning and less eye movement. Slow readers often reread material if they are interrupted and may have a propensity for their rhythm or pace of progression becoming disrupted. In contrast, fast readers typically perceive more information at any given time and can often better memorize text. The system could thus have an awareness of a user's reading style and render aspects of a gamified teaching interface accordingly. For example, the gamification engine could cause text animations in the slow reader's interface to scroll less quickly so that the slow reader has sufficient time to read the text and is less likely to lose interest or become frustrated, etc.

According to embodiments of the present invention, the system may be configured to generate content, navigation, exercises, etc., through intelligent programmatically integrating the various teaching techniques discussed herein into an automated, intelligent training system, numerous educational benefits can be realized that were not previously achievable by human beings or by conventional training software alone. To be clear, the system is not simply implementing human-based teaching techniques. Rather, a new automated, intelligent training system is created that teaches differently than a human but obtains the benefits of those techniques.

For examples, the present system can promote active memory archiving and neural interconnecting, allowing students to restructure existing knowledge as opposed to merely memorizing content for the sake of a test. The present system can further encourage students to remain in an attentive state and respond better emotionally as compared to conventional test taking. Such learning further promotes the gradual building of progressively more complex techniques and knowledge as students learn and practice better training habits. In some embodiments, gamification can involve the use of “tricks” and other similar techniques designed to obscure one or more aspects of the training environment from the user (e.g. making it less likely that the user perceives the training as tedious since they are more immersed in the gamified presentation of the content).

As discussed above, the present invention combines electronic gamification with structured digital learning, low stakes retrieval, and other techniques. This multifaceted teaching system is further combined with an intelligent feedback system for improving and optimizing the learning experience. Specifically, the system can progressively or iteratively update content and system logic/intelligence as more historical and diagnostic data is acquired and as students navigate through various stages of content. Such a system is especially suited for group learning environments (e.g. institutional, organizational, professional learning, etc.) where outcomes have varying positive versus negative effects on different members of the group and issues such as defensive reactions from certain group members can reduce overall engagement and effectiveness. Further, in such group learning contexts, the system addresses unique needs for streamlining and strengthening the methods and manners in which learning is culled and selected, integrated and stored, and evolved over time as organizational directives change. In organizational learning, problems such as (1) developing and structuring content for groups as opposed to individuals, (2) defensive reactions amongst groups and individuals, and (3) under-developed processes of communication can each pose an obstacle to effective learning. The system's use of intelligence and gamification can help mitigate these reduce these problems by (1) automatically structuring group versus individual using algorithms and database intelligence, (2) using gamification to increase emotional dynamics among participants, and (3) providing communication by automatically generating both training content and presenting the content to groups and users.

The system described in the present invention is further capable of (1) storing intelligence data for (2) associating and structuring other data elements that influence learning, and (3) for deriving meaning or logic from said associations or structure. Using such intelligence, the system is able to derive knowledge or understanding from free form text data.

For example, the system can include intelligence data such as structured semantic elements for associating raw or primitive data with higher-order concepts. Semantics is a branch of linguistics and logic concerned with meaning. There are a number of branches of semantics, such as conceptual semantics, which studies the cognitive structure of meaning. Semantic elements include elements of code that are associated with word(s), either in a human language or a computer language. This is why semantic elements and semantic structures (e.g. organic, stored relations between semantic elements) are so important for the storage of knowledge and information from free form text. Semantics are paramount for understanding information, and the benefit of semantic (e.g. Semantic HTML, semantic markup) is based on such a desire to communicate meaning. For example. semantic tags on a document offer additional information about that document.

According to several aspects and implementations of an adaptive training system, one or more of the engines or databases discussed herein may store, execute, or operate upon semantic elements as is needed for generating gamified interfaces, updating system intelligence, utilizing machine learning intelligence, etc. In various contexts a semantic element can refer to one or more objects, methods, instructions, data elements, links, pointers, or any combination thereof so long as the semantic element contains or is associated with free-format text.

The present system includes one or more human-machine interfaces for receiving input stimuli from users or displaying output stimuli to users. Examples of human-machine interfaces intended for use with the system include computers, IoT devices, displays, keyboards, tactile screens, smell or taste interfaces, motion interfaces, augmented or virtual reality interfaces, robots and robot-like devices, holographic projectors, gaming consoles and controllers, lighting equipment, smart hubs, sensors, fixtures, and appliances, networked or internet-connected devices that capable of receiving any form of input stimuli or generating any form of output stimuli, wearables, etc.

The adaptive teaching system further includes a gamification engine for generating gamified training interfaces that users can interact with via the one or more human-machine interfaces. Each gamified interface presents gamified content using a plurality of gamified elements (sometimes in conjunction with one or more non-gamified elements). The gamification engine presents users with gamified interface capable of displaying gamified content and/or receiving gamified user interactions. User interactions with a gamified interface can be facilitated by direct user interaction with one or more associated human-machine interface(s) communicatively coupled to the gamified interface. Gamification can include the use of immediate or sequenced rewards or incentives that would not normally be present in a conventional test taking context.

Gamification describes, in part, the use of game-like elements to present information in a way that engages a user's senses, emotions, or cognition in a way that free-format text alone cannot achieve. It is well known that people prefer to learn and interact via different modes of communication. Integrating gamification into the human-machine interactions, in conjunction with the integration of other teaching techniques described herein, allows for creation of a digital, automated teaching system more capable of accommodating students with special needs, mental health problems, personality disorders, etc. By providing a low stakes environment that is sufficiently engaging, the present system promotes emotional stability and engagement during learning (e.g. to the point where a training exercise might even be perceived as fun, effortless, or painless, etc.).

Gamification can be used to create gamified interfaces for use in the administration of test and treatment content in the present system. Test and treatment content can include, but is not limited to, requests and response interactions, participant interactions, and all forms of input/output communication, etc. User input activity can include answering multiple choice questions, typing in a text response, selecting a multimedia object, performing an action to be recorded, or otherwise interacting with any human-machine interface or IoT device discussed herein.

A gamified interface can be understood as including a plurality of gamified elements, each of which include at least one gamified attribute not present in free-format text data. Gamified elements can include gamified content, such as stylized text, or properties of gamified content such as animations, colors, fonts, graphics, etc. Gamified content can include combinations of text, images, sounds, videos, other multimedia, sensory elements (e.g. as enabled by taste, smell, and/or tactile interfaces), or any combination thereof. Gamified elements can also include properties associated with how the gamified content is presented and manipulated, such as game dynamics like the pace of interactions or content progression.

Certain gamified elements might be introduced specifically for certain types of treatments. For example, an employee undergoing organizational training could interact with a human-machine interface having facial animation or facial recognition functionality. The employee's perceptions of a robot's facial expressions and a camera's interpretations of the employee's facial expressions could be used to analyze complex human emotions. Testing information obtained from the human-machine interfaces can be fed back into the system and used to update the gamification elements used in the current or in subsequent testing/treatment content. The set of responses generated by the users' interaction with the specialized emotional interface may allow for a more robust statistical or pattern analysis of the group testing data yielding more granular or useful diagnostic results or more granular intelligence parameters for improving the overall teaching system.

One gamification technique is known as gami-animation. With gami-animation, one or more gamified elements including gamified representations of free-format text data and other content can be presented to a user in an animated manner. Users may be allowed to control certain parameters of the content or animations at different points in a sequence or as animations develop. In some implementations of gami-animation, gamified elements including gamified content may remain fully or partially constant during an animation event, while other gamified elements (e.g. the manner in which the information is presented to the user's senses) may change over time. In certain examples, the user does not initially have any control over these changes. Various portions of gamified content can be animated in different directions/patterns, at different rates, etc. As additional time passes or at a subsequent stage in the content, the user may be given progressively more control over these changes.

For example, the system may be configured so that content that has been gami-animated scrolls across a user's screen at a certain rate. The user initially has no control over the scrolling behavior of the content, but subsequently, after one or more conditions have been met (e.g. certain interactions completed, certain amount of time passes, some combination thereof, etc.), the system interface may allow the user to control aspects of the animation behavior or their ability to interact therewith. For example, the user could gain the ability to pause the animation or change a property of the animation. To the extent that the user does not always control the full extent of their interaction with various animations, the user's experience and metacognition can be influenced in ways that enhance the learning or training process. Other examples of gami-animation include varying the transparency/opacity of certain windows or content; minimizing, maximizing, or resizing windows; modifying and repositioning windows relative to each other, including partially or completely overlaying some content over other content.

Also as an example of gami-animation, at least part of the information being presented to the user may be shown to the user through displayed animation, meaning that one or more text strings, or figures containing information charts, may glide in the screen, and/or where text strings or information charts may be divided in parts to be separated or brought together, where such parts of the text strings or charts may be defined by separating colors. In one particular screen following this type of gami-animation, everything displayed that is of the color red, be it text or graphics, will glide to the right while everything else will glide to the left. In another screen with the same type of animation, particular characters in the string, or even parts or segments of each character (a letter, number or symbol) such as, for example, the top half of each letter, number or symbol, may glide separately in one direction while everything else glides in another direction. Then, if the user provides a specific response or answer to the exercise, this gami-animation will bring all parts together, either by merging them or by gradually hiding one part behind the other. All these are examples of low stress, partially gamified animations provided for enhanced learning.

Another aspect of gami-animation can include part of the information or content being presented to the user through sound animation, meaning voice or sound recordings or other types of pre-recorded media, or text-based generated speech containing information that gradually may change in speed, tone, or use of vocabulary (by exchanging synonyms), and where user(s) may be offered means to partially control the manner this information is offered or how it changes through time, by interacting in any type of interface, such as speaking into a microphone, or typing into a keyboard, or acting upon an input/output device of other types, following its stated mode of operation.

Finally, gami-animation may execute through combined forms of animation, providing displayed animation, and/or sound animation, and/or animation such as variations in the manner (movement, smell, or other) any interface device is capable of acting, corresponding to the particular mechanics of those things. In one example, a movable chair similar in operation to the enhanced 5th dimensional chairs of current movie theaters, where many different types of movement, slight spraying to the user, localized sound, smell, etc., may be used, may change the particular manner in which those actions take place, like for example by increasing or decreasing the volume of water in the slight spraying mechanism, dependent on what answers the user provides to the interface.

Another aspect of gamification involves the use of avatars (e.g. virtual representations of real persons) and characters (e.g. representations of fictional personas, pets, etc.) to enhance the user's cognitive perception and emotional responses. By simulating certain “real-life” interactions through the use of said avatars and characters, the emotional involvement of the user can be increased without creating undue stress or stakes. For example, an animated guide (perhaps stylized as a friendly animal character or the like) can interact with the user throughout a lesson and explain certain navigational rules, etc. The user may feel an emotional attachment to the character and have a greater incentive to participate in the exercise or participate more effectively. In another example, a treatment program for rehabilitating domestic violence could involve a participant engaging a virtual reality interface representing another person thus allowing the participant to feel as if they are embodying another (e.g. a virtual representation of a non-abusive spouse).

Some gamified exercises may be administered collaboratively to a plurality of participants with, for example, the use of multiple digital devices. Participants may collaborate on testing exercises remotely or at common physical testing sites, at common, separate, or partially overlapping times. Collaborative exercises may involve content requiring participants be physically present at the same testing site, possibly at the same time. Participants at the same physical site may share interfaces or terminals or use entirely separate interfaces or terminals during the administration of gamified content. In such group or institutional contexts, gamified content may instruct users to perform actions such as interacting with other participants. For example, one user may receive instructions to interact with another user directly (e.g. switching seats with another user), instruct another user to interact with one of the gamified interfaces in a certain way (e.g. answer a certain question on their interface a certain way), assign tasks to other users, etc.

Another aspect of gamification is the extent to which content has been gamified. On one extreme, there is purely non-gamified content administered as a conventional test comprised entirely or almost exclusively of free format text data. On the other extreme, there is fully gamified content (i.e. games) that involves little to no free format text data and is composed primarily or entirely of gamified elements. In between these two extremes are various states of partial gamification, each involving selective or intelligent gamification of certain content, as well as determining how and when said elements should be gamified, etc. There may be many degrees of partial gamification ranging from hardly gamified to almost exclusively gamified. The gamification engine may store and calculate one or more gamification values such as a total gamification score or one or more gamification category scores. Scored gamification categories may include any or all of the parameters associated with gamification discussed herein, or any combination or logic grouping thereof. Such scores may be stored in one of the databases and associated with data such as content, users, lessons, diagnostics, event history, etc. Using the scores and their respective associations, the gamification engine can generate a gamified interface having a degree of partial gamification that is optimized for the needs of the user.

Partial gamification can be used to balance gamification elements so as to create a treatment style that is better optimized for users with certain conditions, personality traits, learning styles, beliefs, knowledge, personal attributes, etc. For example, a partially gamified treatment can create a user experience that minimizes the distraction issues associated with non-gamified content (e.g. a poor standardized test taker) and seems relatively low-stakes from the user's perspective (in contrast to a full game, e.g. a video game, which could be so immersive/visceral that it is perceived as high-stakes/stressful). Some overly gamified environments can elicit a response of stress, anxiety, or perception of high stakes. Introducing the proper amount of gamification can avoid these issues while stimulating student interest, attention, and effort. These benefits can be further enhanced in some implementations by introducing rewards and other immediate feedback into the gamified content. In summary, the use of partial gamification involves striking a balance between reducing distractions and reducing the perceived stakes associated with evaluative teaching in order to maximize user engagement and learning efficacy.

The gamification engine produces gamified interfaces containing gamified representations of various data elements. For example, free-format text can be represented using graphics, colors, animations, etc. that change how the content is perceived and interpreted by human viewers as compared to its raw/unstructured form (e.g. plaintext representation). A gamified interface can be used as an evaluative tool for presenting interactive teaching content to users and soliciting their feedback in the form of gamified responses. A gamified interface can further be used as a treatment tool for providing treatments in a gamified manner, some of which may involve gamified feedback (such as gauging a user's response to a treatment session in real time).

One example of a gamified element is the use of scores or rewards. For example, a test or treatment can provide the user with one or more scores at the conclusion of each question, step, lesson, chapter, program, etc. Scores may themselves be gamified, such as using a large and colorful font, or animations. In the group context, metrics such as the average score obtained by others engaged in the same or a similar program can be displayed. Scores may further be sub-divided into numerous score categories. For example, scores may be numeric, percentage-based, letter-based, or incentive based. Gamified interactions may further include reward elements such as level progression, quest progression, digital items, badges, titles, special character or avatar interactions, etc.

Another aspect of learning related to gamification is the concept of metacognition (a form of active cognition), which describes a state in which an individual is at least partially conscious of their own thinking, emotional, and other cognitive states. Students in a state of metacognition can often improve their learning performance by forming better structure and visualizing their learning in ways that would otherwise not be possible. Gamification has been shown to help induce states of metacognition by, for example, reducing student distractedness, anxiety, or other negative conditions and emotional responses and allowing the student to focus on their own mental processes. Metacognition need not be fully conscious to be productive. Further, through gamification, students can train themselves to automatically/habitually engage in metacognition as part of their learning process.

Another aspect of gamification involves the use of various gamified elements to manipulate a perceived mood or tone associated with content. For example, gamification elements introducing fun factors can therefore be used by the gamification engine to make a gamified interface more engaging, fun, or playful without it completely seeming like a game. In this light, game design elements to be used when creating the concept of a partially gamified application can include, for example, elements representing badges, levels, leaderboards, game mechanics, evaluations of design solutions, conceptual models of game design units, game design methods (e.g. playtesting), or any combination thereof. In all cases, as in cases when social elements and organizational experiences are added, an important consideration for applying these gamification elements is finding the appropriate time and fashion for introducing said elements into the gamified interface. The status of whether a test is group administered versus individual may also affect how and when gamification elements are introduced.

In one example implementation, a user undergoing a training program for suspected substance dependency is provided with one or more virtual reality (VR) human-machine interfaces having a virtual reality display and headphones for presenting a gamified virtual reality training interface. Therapy techniques such as cognitive-conductual therapy or dialectical therapy have been shown to be particularly effective for substance dependency disorders, but conventionally require a human being with advanced professional qualifications to administer said therapies. The present system can administer treatment content in an automated fashion via the gamified interface and is thus capable of capitalizing on the proven therapeutic effectiveness of certain techniques without necessarily requiring any human involvement on the administration side (i.e. no human professional need be present to administer or evaluate the test or treatment results). One further benefit of gamification or partial gamification can include the ability to administer various types of training, tests, or therapy while obscuring the user's awareness of the type of therapy they are engaging in. As such, the subject can more readily learn and master such techniques without having a potentially adverse reaction to non-gamified or face-to-face/manual therapy.

Aspects and embodiments of the present invention include one or more memory storage facilities, such as databases including a content database for storing content data, an event history database for storing event history data, a navigational database for storing navigational data, a diagnostic database for storing diagnostic data, or an intelligence database for storing intelligence data. Each element referred to as a singular database may instead involve a plurality of databases that collectively enable the described database functionality. Some or all of the functionality or structure described with respect to one database may alternatively be implemented on one or more other databases. Each database can be a referential database (including self-referential databases), and can include pointers or links associating database elements with elements in other databases. For example, a first data element comprised of free-format text representing a test question that includes the term “infant” can be stored in one database, a second data element representing a diagnosis of “post-partum depression” can be stored in another database, and a third data element stored in a third database can store a canonical/semantic identifier for “pregnancy,” which is associated with or otherwise linked with both the first and second data elements. This relationship provides the system with a level of intelligence by giving it an understanding that testing content relating to infants and a diagnosis of post-partum depression both relate to the same concept (i.e. pregnancy).

Various types of databases and memory devices can be included in the system of the present invention. In certain embodiments and examples, the system may include one or more content database(s), for storing content data to be used in the generation of gamified training interfaces. The content database stores free format text data in addition to content elements such as images, videos, vector-based animations, computer generated imagery (CGI, 3D computer graphics used for creating scenes or special effects), interactive computer graphics, code objects, multimedia objects, etc. The content database can further store data content elements that are derived from operations applied to one or more content element (for example parameters representing one or more combinations of logical or numeric operations applied to one or more content elements). The content database can further store associations between various content elements or derived elements. The content database can further store associations between content elements or derived content elements and other data elements stored in other databases.

The system can further include an event history database for storing event history data. Event history data may include, for example, any number of parameters describing previous user interactions with the adaptive training system. For example, response text to certain exercises, user response selections or behavior in response to any manner of prompt, screen, or stimuli presented to the user, individual keystrokes, response timing information, every prompt or screen presented to the user, etc. Any aspect of user input involving one or more of the human-machine interfaces can be recorded by the interface and sent to the system to be stored in an appropriate data structure or data element.

The system can further include a navigational database for storing navigational data, such as navigational maps providing navigational paths and sequencing of treatment content, progress maps for indexing the current treatment progress of users within their respective navigational map(s).

The navigational data can describe the structure for an entire treatment program (e.g. a navigational map). The navigational data can arrange and associate treatment content hierarchically, sequentially, or in accordance with any desired structure, progression, or logical flow. For example, a certain question can be associated with one or more lessons, each lesson associated with one or more chapters, each chapter associated with one or more programs, etc. The navigational data can store preferred content in additional to one or more alternative instances or sets of content. The navigational data can rank alternative instances or sets of content for various positions in the navigational map. The navigational data can also store the current position of users and groups within the overall navigational map of a given treatment program.

In some embodiments, the navigational database can store a participant data including participant attributes (e.g. name, age, organization, username, password, etc.) and other participant configuration data. Alternatively, participant data can be stored partially or completely in the event history database.

Navigational maps stored in the navigational database can include data elements for mapping the organizational relationships or hierarchy between various treatment programs, chapters, lessons, screens, questions, and other testing or treatment content. In various examples, a question can be associated with one or more lessons, a lesson can be associated with one or more chapters, a chapter can be associated with one or more programs, and vice versa. A question can be associated with one or more alternative questions or follow-up questions. A navigational map can thus store logical associations between content at varying levels in the organizational hierarchy. For example, a navigational map of lesson progression can indicate that a first lesson for acquiring identifying information associated with the user, should be followed by a second lesson for gaining a rough or general understanding of a student's learning issues, which should be followed by a third lesson for generating a list of possible diagnoses, which should be followed by a fourth lesson for identifying a specific diagnosis, which should be followed by a fifth lesson for confirming the suspected diagnosis above a threshold level of certainty, which should be followed by a sixth lesson for providing initial treatment, which should be followed by a seventh lesson for evaluating treatment progress and providing further treatment instructions, etc. An initial navigational map associated with a user may be updated or modified as treatment progresses and additional system intelligence and user feedback is acquired and analyzed.

The navigational database can further store information for keeping track of group training sessions. For example, navigational database can keep track of associations between the individual treatment steps, cases, exercises or programs that collectively make up a group treatment program. The navigation database, can further keep track of each individual participant's progress with their individual treatment programs, each individual's overall progress within the group's collective treatment program, the overall progress of the group treatment plan collectively, etc. Navigational control of treatment programs may follow the example of the most sophisticated project workflows in current art. Coordination between different tasks and differentiated group work is possible with added intelligence. Screen interactions and interfaces may include communication between different participants. In this manner, navigational control and coordination improves on group and collaborative learning.

The system can further include a diagnostic database for storing diagnostic data, such as diagnostic parameters and related diagnostic parameters. Diagnostics and related diagnostic parameters can include numerical values, formulas, functional procedures, or pointers, all or any of which may identify specific conditions using free-format text (for example in the name or names associated with the condition), semantic parameters such as canonical names or diagnostic categories, probabilistic values of each simple or combined diagnostic ready for fuzzy logic application, pointers to associated free format data or to associated events in the history database, plus one or more conditional groups of functional code that may apply depending on certain conditions being met and are capable of executing specific actions such as recording new history, activating new or updated gamified navigation paths, generating alarms or adding specific items (such as the diagnostic) to particular user menus, generating dialogs, activating machinery or robots into a particular predefined action. All these are specific examples of parameters that may be stored in the diagnostics database.

Examples categories of conditions that can be identified by a diagnostic parameter include learning disabilities, psychological conditions, social issues, cognitive disorders, specific physical or emotional habits or reactive practices that may be positive or negative in any particular situation. Specific examples of conditions that the system could be capable of diagnosing, both in the context of individual training and group training, include anxiety disorders, depression, dysthymia, alcohol or substance disorders, borderline personality disorder, schizophrenia, bipolar disorder, somatoform disorders, eating disorders, insomnia, other psychotic or personality disorders, anger or aggression issues, criminal behaviors, general stress, distress due to other medical conditions, chronic pain or fatigue, distress related to pregnancy or female hormonal conditions, productivity issues, attention disorders, and others.

This diagnostic capabilities of the invention are in part possible because in current times, treatment programs such as cognitive behavioral therapy (CBT) both benefit from and contribute to automated or semi-automated collaboration through statistical evaluation of actions taken and final results for particular cases and patients, and CBT is based in a methodology that is capable of being presented through a printed or electronic manual or practical application handbook with guided exercises. There is a predefined sequence of training, learning and interactive activities that are particularly suitable for the invention. CBT is being successfully applied to a large number of conditions and, also, there is now a significant number of second and third level therapy therapy methods applicable to the same and other conditions. Some of these therapy methods partially stem from CBT and that share some of CBT's characteristics.

Diagnostic parameters and related parameters, and their respective associations (e.g. pointers, links, logical relationships, other intra or inter-database data constructs or references), can be used to meaningfully relate or analyze various diagnostic conditions, diagnostic categories, and other data elements in other databases to further enhance system intelligence. For example, the two diagnostic conditions “schizophrenia” and “substance abuse” can be directly linked within the diagnostic database, or could be mutually correlated a diagnostic parameter, such as a mutual incidence value (e.g. 40% in one direction, 5% in the other) indicating the likelihood that one condition presents with the other in the same person. The two conditions could further be associated with a diagnostic parameter representing a diagnostic category of “schizoid type disorders.” Diagnostic parameters and elements in the diagnostic database can further be linked to parameters and elements in other databases. For example, the canonical data element identifying schizophrenia in the diagnostic database can be linked to a free format text element in the content database including the term “hallucinations” or “paranoid”. The schizophrenia data element could further be associated with event history data in the event history database corresponding to students who've previously been diagnosed with a schizoid type disorder. Or similarly, the schizophrenia data element could be associated with a caution flag in the intelligence database. Suggested treatment steps that are associated with the caution flag may prompt the system to take additional action or care (e.g. increasing the level of gamification, increasing the extent of rewards, modifying participant interactions in a group setting, signaling a human instructor/supervisor to personally interact with a user for certain content, etc.).

It is important to note that a diagnostic result can be thought of as representing a suspected association or correlation between two or more data elements or data structures that meets or exceeds one or more thresholds. The system may perform evaluations to ascertain a degree of certainty associated with a diagnostic result and compare the degree to the one or more thresholds to determine a confidence rating associated with a diagnostic result. In various instances, a threshold may refer to a numerical threshold (e.g. >x) or a logical threshold (e.g. TRUE) or combinations thereof. In particular, fuzzy logic, such as that described in U.S. Pat. No. 5,701,400, may be applied for this purpose, since probability values of any diagnostics being true may be used to generate new such fuzzy logic values for further generated diagnostics (i.e., “super diagnostics”) stemming from these.

For example, a set of test/text data could generate a set of diagnostic results with a primary diagnostic result estimating that the test data is 20% likely to be correlated with a condition such as bipolar disorder. Despite the degree of correlation being less than 50%, the primary diagnostic result may nevertheless represent the most likely diagnoses at any given time. In cases where there is a relatively low degree of correlation, the system can elect to conduct additional testing using additional gamified test/text interfaces having new content and/or new navigational paths. In other cases, such as where the primary diagnostic result is higher than 80%, the system can elect to provide a therapeutic instruction to the user prompting them to take remedial action.

The system may be customized such that for certain users or diagnostics the correlation thresholds for providing a therapeutic response versus performing additional testing is set to an appropriate value. These values may be based on factors such as the severity or prevalence of certain conditions, or other measurable/quantifiable factors capable of being stored as diagnostic parameters. For example, a diagnostic result estimating a 25% chance or more of schizophrenia may be considered sufficient to trigger a therapeutic response, whereas a diagnostic result identifying depression may need to exceed 75% correlation to trigger a therapeutic response (e.g. since the first condition is often considered more severe or dangerous than the second condition).

The system can further maintain super diagnostic parameters in the diagnostic database. A super diagnostic refers to a diagnostic result either comprised of multiple other diagnostic results that have been correlated to a super diagnostic result, or a diagnostic result that has been further validated or improved based on additional intelligence or analytics. In various embodiments, the system can decide to evaluate a super diagnostic only once certain conditions have been met (for example conditions relating to the user, the progress of their treatment, current diagnostic results that have been generated, etc.). In certain embodiments, the machine learning engine can use a machine learning algorithm to specifically validate or generate a super diagnostic.

In cases where the system identifies a diagnostic result with sufficient certainty, and thus determines that a treatment response, action, or report is appropriate, the gamification engine can generate an updated gamified interface for presenting the treatment content. In some embodiments, will instruct the user to take one or more remedial actions. Examples of remedial actions can include, instructions to engage in one or more therapies such as cognitive behavioral therapy (CBT), acceptance and commitment therapy (ACT), dialectical behavior therapy (DBT), mode deactivation therapy (MDT), mindfulness interventions, problem-solving therapy, behavioral activation, interpersonal psychotherapy, digital treatments such as positive cognitive bias modification, digital CBT, and others, or any combination thereof. In other embodiments, a treatment response will involve providing diagnostics reports, scores, rewards, analysis, etc. Much like a testing session, a treatment response session can involve any number or sequence of inputs, outputs, or interactions between a user and the gamified interface using the available/compatible human-machine interfaces.

The system can further include an intelligence database for storing intelligence data. Intelligence data can store logical or semantic associations between data elements from other databases so that the system can more meaningfully interpret the significance of various data stored throughout the system. The intelligence data further can store intermediate values or derived values that are not necessarily presented to users, but are used by the system internally for determining how to generate gamified training content. For example, certain test questions or responses can be associated with an emotional intelligence parameter in the intelligence database, whereas other questions or response can be associated with a mathematical intelligence parameter in the intelligence database. The system can refer to the intelligence database when generating a new lesson and, for example, elect to use one question over the other based on additional intelligence indicating the user's preferred learning style.

In some embodiments, the intelligence database (or any other database) can be occasionally be optimized or reorganized by the system based on new data. In certain examples, the machine learning engine can interact directly with or restructure the intelligence database (or any other database) by running one or more machine learning algorithms on the appropriate database(s). The selection of which databases the machine learning engine has access to is a design decision that system operators can control or modify depending on the way the databases are structured and the availability of machine learning algorithms and training data sets.

The intelligence database can thus store and associate data elements and data structures of all manners, including data elements or associations relating to logical or semantic parameters that enable the system to intelligently adapt to users as they progress through content. Such associations can be explicitly stored or defined as data elements, references, links, pointers, etc., and can specify internal references between parameters within the intelligence database or external references associating parameters in the intelligence database with one or more data elements or data structures stored in other databases.

The intelligence database can be structured such that it is readily conducive for being parsed by an algorithm for generating logical data on demand (for example an algorithm of relatively low complexity versus a high complexity algorithm that would be required if the data were structured differently). For example, an intelligence database may store a row or column of entries that logically pre-parses one or more additional rows or columns using a logical statement (such as true-or-false, if-then-else, AND, XOR, etc., or any combination thereof). This pre-parsing may generate an intermediate value that has some logical or semantic significance and can further associated with other data elements throughout the system or further parsed to generate additional logical results capable of informing system decision making. The system may combine the use of pre-parsing with the use of real time parsing algorithms to customize the organization of logical relationships between various system parameters in accordance with operational needs. In this way, the system can balance which portions of the system intelligence should be stored in the databases as opposed to executed at runtime.

In the context of this invention, an intelligence database contains intelligence and, in an adaptive teaching system, it shall contain any type of coded interpretation of content information and/or coded interpretation of history records of transactional interactions between users and the adaptive teaching system. Content information is presented to the user via a gamified representation, under control by the gamification engine coupled to the content database. Coded interpretation of content information may be obtained through the application of logical tests to obtain diagnostics, or by pattern matching by machine learning algorithms, or by intelligent classifier systems or other intelligent tools (genetic, neural, deep learning, etc.), or even by simply storing human intervention coded as diagnostics, that is, by learning from human actions (when certain conditions are present, action taken by X individual is Y), or by simply writing the coded interpretation of content information through direct human intervention. The final result may be stored as diagnostics, and it can also be stored as a particular collection of semantic elements, in a specific networked semantic structure.

Semantic structures may divide text into specific elements that are usually coded for interpretation, and networked to show cause-effect or any other types of association between semantic elements or groups of semantic elements. As such, semantic elements can be powerful coding structures that store an interpretation of information, and they are, for this reason, a coded interpretation of information and, as such, this coding is part of the intelligence database.

In a series of embodiments, a machine learning engine is coupled to the gamification engine and one or more databases. The machine learning engine can run one or more machine learning algorithms analyzing or restructuring data elements in the databases. For example, a diagnostic database for storing diagnoses and associated parameters can occasionally be parsed by the machine learning engine. The parsing can involve one or more machine learning algorithms for identifying patterns or correlations between various sets of data. Machine learning algorithms implemented by the machine learning engine can be used to implement various techniques such as organic knowledge (OK), gestalt-multiplex-layering (GML), and knowledge engineering (KE).

OK evolves using feedback and data-to-knowledge mechanisms. By process of feedback and natural selection, the solution gradually improves using the growing body of knowledge. OK, for example, may facilitate better interaction between humans and machines searching for a solution, or for better collaboration by different types of distributed, learning or knowledge engineering engines. GML involves creating deeper models of expert knowledge and reasoning processes, for example using layering (e.g. hierarchical layering of processes or control).

The execution of a machine learning algorithm can further involve retrieving training data one or more an external/remote databases coupled to the machine learning engine (such as expert databases). Based on comparison results or pattern matches generated by the machine learning algorithm(s), the system can revise, modify, restructure, or otherwise update the diagnostic database or one of the other databases as appropriate. In a further example, perhaps very recent medical research has shown a higher than previously realized correlation between schizoid type disorders and substance abuse. When the machine learning engine parses the diagnostic database with an algorithm that has access to the new medical data, one or more data elements in the diagnostic database can be modified to improve the diagnostic accuracy of the teaching system. For example, a data element in the diagnostic database representing a “substance abuse” entry can be linked or correlated with a data element representing “schizophrenia” entry and vice versa.

Approaches for implementing machine learning techniques (also referred to as machine intelligence, artificial intelligence, etc.) for data analysis via the machine learning engine include classifier systems (pattern search) and logic matching. Machine learning can further aid in the analysis of data that includes semantic elements and structures. For example, machine learning algorithms can assist in the identification and analysis of certain patterns (e.g. semantic elements) that would otherwise be difficult or impossible for conventional algorithms to meaningful analyze. Machine learning also involves knowledge representation and reasoning, insofar as data elements can be structured in ways that allow a computer system to perform complex tasks that generate meaningful results. For example, machine learning can be used to identify patterns associated with diagnostic conditions and other diagnostic parameters or identify semantic patterns relating to natural language usage (e.g. the use of canonical names to categorize natural language data or use of grammatical algorithms for parsing dialogue, etc.). With regard to knowledge representation, machine learning be used in the creation and analysis of semantic nets, systems architectures, frames, rules, ontologies. Examples of automated reasoning include inference engines, theorem provers, and classifiers.

Machine learning algorithms and/or training data can be stored locally or called remotely, for example using Internet-accessible application programming interface (API). The machine learning engine can further outsource some or all processing responsibilities to one or more external servers or the like.

According to aspects of the present invention, the machine learning engine runs machine learning algorithms, some of which can be stored locally, and others which can be called from other physical sources such as an external API. These machine learning algorithms can run on some of the invention's databases to help identify patterns and reorganize the databases. For example, the invention may first present some text information to the users, which may include one or more tests or requests, some of which may be accompanied by corresponding background information, and the user will make a choice by responding to those tests or requests in any of a number of different manners. Some or all information on those interactions may be stored in a history database, where this database may contain a record of each event plus link pointers to any text information screens associated to each such record. Some of the invention's databases may be connected to the internet for occassional or periodic updating of their information. The machine learning engine then queries and compares patterns in the invention's intelligence database with contents in the history database and any linked text screens, may also execute selected tests on such patterns and contents and may generate, among other new intelligence information, new diagnostics to be stored in a diagnostics database.

In this and other manners, in one embodiment the machine learning engine can be configured to most frequently or most likely interact with the diagnostic database, and based on said interactions reoptimize the diagnostic associations and/or link pointers to the data and history database events and records associated to such diagnostics. This can be achieved by, for example, using more powerful machine learning algorithms and/or by importing additional diagnostic data, such as new expert data reflecting a more current understanding of various diagnoses. The machine learning engine can be configured to interact with or be fully or partially controlled by the gamification engine or interactions engine. The machine learning engine can be configured to access databases indirectly, for example via a linking module, for promoting security/isolation. Alternatively, the machine learning engine can be configured to interact directly with certain databases if given permission by the system operator.

As discussed above, the machine learning engine can store and execute one or more machine learning models. A machine learning model can involve using one or more a training datasets (each training dataset including a plurality of training examples); processing one or more the training datasets in accordance with one or more machine learning algorithms; determining uncertainty scores for the plurality of training examples based on the one or more machine learning algorithms; selecting a first example batch from the plurality of training examples according to uncertainty scores of the plurality of training examples; updating the machine learning model according to at least one uncertainty score or training example; determining updated uncertainty scores for the plurality of training examples according to the updated machine learning model; and selecting a second example batch from the plurality of training examples according to the updated uncertainty scores of the plurality of training examples. Said process can be executed repeatedly or iteratively to progressively generate more accurate or robust training examples or uncertainty scores. A machine learning model may be trained with human labeled data examples and may be updated as the examples are labeled. A subset or batch of data examples may be selected from a complete data set according to their uncertainty levels. As the batch of data examples are labeled, a machine learning model may be updated and applied to the remaining batch data examples to update their uncertainty levels. The machine learning engine or a user may select the most uncertain data example from the batch for labeling. As the engine or the user continues to label examples of the batch dataset, the engine may rescore the complete dataset to select the next batch of examples to be provided as the first batch is completed, thus providing a lag-free and efficient machine learning model training system.

The system may further include a linking module, for communicatively coupling the various databases and engines described herein. The linking module may include one or more signal lines/fabric/interconnect/buses/etc. implemented in hardware or partially in hardware vs. partially in software for facilitating connectivity between the databases and engines such that data can be exchanged across the system as needed. The linking module may support protocols such as direct memory access (DMA). The linking module may further be configured to make use of links, pointers, or other linking structures/mechanisms known in the art. The linking module may further be configured to make use of any or all objects, functions, or instructions associated with database management systems to faciliatate communication between any two respective engines or databases discussed herein.

The system may further include an interactions engine for managing or processing interactions between the various databases and engine components described herein.

Certain aspects of the invention involve the system adaptively generating new system data—e.g. content, rules, logic, diagnostics, etc. The interactions engine, in conjunction with one or more of the engines or databases (e.g. the intelligence database), can determine that new system data is required and responsively execute one or more system data generation algorithms for generating new system data. For example, the system can run a testing content generation algorithm for creating a new test question based on new medical intelligence (e.g. a diagnosis question updated to reflect newly discovered causes of the suspected condition). Or the system could run an intelligence algorithm to compare respective elements in two or more databases and update links/pointers therebetween or logical/mathematical references thereof (e.g. an element representing a 50% correlation between a test question element and a diagnosis element updated to a 60% correlation when new comparison is run accounting for more recent diagnostic data).

The interactions engine can further execute instructions for operating on or relating various data elements (e.g. participant data, content data, event history data, diagnostic data, intelligence data, etc.) to facilitate the interactions for generating training content. For example, the interactions engine can execute various algorithms, logic, objectives, etc., for enabling the system to intelligently and adaptively generate content that is tailored to the educational needs of a particular user or group setting.

In the various embodiments and examples discussed herein, it is important to note that functionality discussed as being implemented on the gamification engine, machine learning engine, or interactions engine can be executed on any arrangement of sufficiently powerful hardware components including servers, clusters, computers, processors, chips, embedded devices and the respective instructions, firmware, or software stored thereon. One or more of said components may execute functionality associated with any number of the engines. In addition, functionality described herein as being associated with one of the engines may alternatively, additionally, or partially be implemented on one or more of the other engines. In other words, the separation/grouping of engines may be logical as opposed to physical. Similarly, the various databases, data structures, and data elements discussed herein may partially or fully overlap in their use of common storage hardware, or otherwise utilize distinct hardware.

As explained throughout this document, in this invention, gamified interfaces provide an adaptable and dynamic low-stress testing environment for effective learning. Users, i.e., students and/or other participants interact with these gamified interfaces and find, in these, among other, responsive screens depending on responsive navigational data. By screens, we refer to any type of presentation of content to the user, be it through brain-mind integration, sight, sound, smell, tactile, movement based, or any signals or signal types sent to any user human senses. Gamified interfaces provide gamification via a measured appearance of a limited dose of interactions or results that are or may be unexpected to the user.

Two examples of such unexpected interactions may include, first, screens where the particular manner in which information is presented may change, often in unexpected ways and, second, unexpected changes in navigation throughout the learning sequence of lessons or experiences. Depending on their actions or responses to tests or requests presented to users, these users may then receive partial control of said unexpected interactions, thus completing the experience for a measured, low-stress partial gamified environment. Some or all such gamified interactions are controlled by the gamification engine in the invention. In this manner, gamification is paramount in its handling of information presentation and navigation within the limits of any learning experience.

The invention's intelligence database and diagnostics database may be separate or may be built into one single intelligence database also containing such diagnostics. The intelligence database and diagnostics database constantly update their information, as explained elsewhere in this same document, and any element or group of elements in their contents may be linked to and back from specific particular records, elements or contents in other databases in the invention, such as, for example, the history database, the text content databases, and/or optional gamification and navigational databases. Additional gamification and navigational databases may, in some cases, be part of the invention, containing information, such as variables and parameters, necessary to execute different types of gamification, or variables and parameters for following a set of different navigational paths.

As explained, the invention is capable of generating and managing, a number of content databases, with a parallel set of intelligence databases, where elements in each set are linked via link pointers or some other similar mechanism with elements on the other set. Users interact with content in any of these databases via the gamification engine and gamified interfaces. Gamified interfaces, may change as new diagnostics are generated, or because of diagnostics associated to any functional code where specific changes to the gamified interfaces are programmed, or after the machine learning engine finds matches any specific patterns, and these matching results are predefined to produce any specific change to the gamified interface.

The various databases disclosed herein including the intelligence database, content database, navigational database, diagnostic database, and event history database (each “database” or, collectively the “databases”) can each include one or more sub-databases each including one or more data structures for storing data elements. Each data element can store raw/unstructured data (such as free format text data) and/or relational data such as pointers or links associating various intra or inter-database elements. Some examples of data structures are arrays, tuples, hash tables, sets, graphs, queues, stacks, lists, records, unions, and other objects for storing data, etc. An example of a database is a relational database system that stores data as rows in relational tables. Alternatively, first list and second list can be a column-oriented database that stores data as sections of columns of data rather than rows of data. This column-oriented approach can have advantages, for example, for data warehouses, customer relationship management systems, and library card catalogues, and other ad hoc inquiry systems where aggregates are computed over large numbers of similar data items. A column-oriented database can be more efficient than a relational database when an aggregate needs to be computed over many rows but only for a notably smaller subset of all columns of data, because reading that smaller subset of data can be faster than reading all data. A column-oriented database can be designed to efficiently return data for an entire column, in as few operations as possible. A column-oriented database can store data by serializing each column of data of the first list and the second list.

In various implementations disclosed herein, each database may further be structured as an active database, a relational database, a self-referential database, a table, a matrix, an array, a flat file, a documented-oriented storage system, a non-relational No-SQL system, and the like, and may be cloud-based or otherwise. Each database described herein can be implemented using any combination of database hardware and associated database management software known in the art.

The interactions engine (or in some examples the gamification engine or machine learning engine) can run code for identifying and associating data elements stored in in the same database or in different databases. Since knowledge can be represented in many ways, there are a potentially infinite number of ways that a given knowledge can be represented in terms of available data elements. To the extent that the present system involves analyzing myriad sources of data to intelligently create custom-tailored treatment programs, the interactions engine can help determine when certain databases, data structures, or data elements should be called or operated on by the various engines disclosed herein. This is especially important when system knowledge or intelligence depends upon complex logical or semantic relationships between underlying data elements.

In one example of the present system's capacity for adaptive and semantic intelligence, consider a case of forming a new association between data elements in separate databases. The system analyzes a set of data elements in the content database that refer to a common geographic location such as “New York City,” “NYC,” “Manhattan,” “Soho,” an image of NYC, a sound recording of New York City′ being phonetically pronounced, etc. By identifying sets of records that reference the same underlying semantic concept, the machine learning system can determine a canonical name for the location and associate all of the records involved with the canonical name. Canonical names may be further associated with database parameters for creating additional relationships between the databases, data structures, and individual data elements therein. For example, the canonical name entry for “NYC” could be further associated with the identities of patients living in NYC (e.g. in the event history database), diagnostic conditions with a high incidence in NYC (e.g. in the diagnostic database), test content involving NYC (e.g. in the content database), and other parameters that bear a logical or semantic relationship with NYC.

The intelligence database may include data elements for storing associations between data elements in one or more of the other databases. For example, a test question in an English-based test may present words in other languages from time-to-time (e.g. content database element); a patient using the system may come from a non-English speaking country (e.g. event history database element); a test question may be part of a lesson for screening language-related difficulties in order to prevent false diagnostics (e.g. navigational database element); and a condition such as dyslexia may be more likely to be falsely identified when language difficulties are present (e.g. diagnostic database element). Within each database or subset of databases, there may not be a sufficiently self-referential structure or scope of data to represent a semantic association between respective data elements. However, by associating these data elements in the respective databases with a database specifically tailored for storing semantic relationships (i.e. the intelligence database), it is possible to provide more meaningful intelligence to the gamification engine via the intelligence database (and also possibly avoiding the need to make the other, non-intelligence databases, significantly more complex). Continuing with the present example, the various data elements discussed above can each be associated with a “language” entry in the intelligence database, thereby allowing the system associate numerous, otherwise disparate data elements with a common semantic concept for subsequent in the creation of gamified test/gamified therapy content.

The gamification engine, interactions engine, and/or machine learning engine can further enhance system intelligence by updating or restructuring the intelligence database to include new association data. The intelligence database may then be called by the gamification engine or the interactions engine during operation of the system to provide system intelligence when generating gamified test/text interfaces. In this way, associations between the various databases can be made persistently available to the system without having to invoke the machine learning engine each time intelligence is needed.

As will be apparent to one of ordinary skill in the art, the present invention improves upon the prior art by combining gamification with machine learning to allow for a more objective analysis of myriad conditions in both an individual or group/organizational context. Using the large data sets and computational power of a machine learning system, the role of subjective elements such as human bias and memory can be eliminated or reduced from the diagnostic process.

A further benefit of the invention involves the ability of the system of generate meaningful tests, diagnostics, and intelligence while anonymizing or securing sensitive data when appropriate, such as personal health data that would otherwise be protected under federal law. For example, in a collaborative learning exercise, the test results or diagnoses of individual users can be fed back into the system and analyzed without exposing the sensitive identifying information to a human being. The system, for example via associations with a “HIPPA” field in the intelligence database, can identify database elements that are confidential and should not be placed in a gamified interface that will be read by an unauthorized human being.

In some embodiments, the machine learning engine, gamification engine, and/or the interactions engine can be split across one or more networked computers, communicatively coupled via a network. In some embodiments, the networked computers can be organized into a distributed computing architecture. For example, the distributed computing architecture can be a system such as Apache Hadoop or Spark. In these embodiments, for example, system functions can run in parallel across one or more nodes of the distributed architecture and can generate collective output, which can later be combined to generate a complete set of results for a given distributed computing process.

In various embodiments discussed herein, any of the diverse engines, modules, and other training software may be implemented on any number or arrangement of hardware devices and their associated operating systems, such devices may contain some type of processor capable of executing program code, and access to memory or information storage, permanent or temporary. Examples of such arrangements may include processing clusters, intelligent servers and any servers of other types, computers and any other intelligent devices, tablets, smartphones, etc., running any sufficiently powerful version of any operating system, or any system software to manage hardware and software resources and providing common services for device executable code, such as Microsoft's Windows, Apple's macOS or iOS, Linux or any Unix variation, Google's Android, or any other such operating system.

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the disclosure. In the figures, each identical or nearly identical component that is illustrated in various figures is represented by a like numeral. For purposes of clarity, not every component may be labeled in every figure.

### BRIEF DESCRIPTION OF THE DRAWINGS

FIGS. 1A-1C are diagrams depicting various embodiments of the gamified training system discussed herein.

FIG. 2 is a diagram depicting a logical representation of an embodiment of a gamified training system.

FIGS. 3A-3B are diagrams depicting interface screens associated with an embodiment of a gamified training system.

FIG. 4 is a diagram illustrating a learning process in accordance with aspects of an intelligent training system herein.

FIG. 5 is a diagram illustrating a learning process in accordance with aspects of an intelligent training system.

FIG. 6 is a flow chart representing a diagnostic process in accordance with aspects of an intelligent or adaptive training system.

FIGS. 7A-7B are diagrams depicting interface screens associated with an embodiment of a gamified training system.

FIGS. 8A-8C are diagrams depicting interface screens associated with an embodiment of a gamified training system.

FIG. 9 is a diagram showing an example interface screen associated with an embodiment of a gamified training system.

FIG. 10 is a diagram illustrating an embodiment of an event history database.

FIG. 11 is a diagram illustrating an embodiment of a content database.

FIG. 12 is a diagram illustrating an embodiment of a navigational database.

FIG. 13 is a diagram illustrating an embodiment of a diagnostic database.

FIG. 14 is a diagram, depicting aspects of gamification as they pertain to embodiments of a gamified training system.

FIG. 15 is a flow chart showing an exemplary diagnostic process in accordance with aspects and embodiments of the present invention.

FIG. 16 is a diagram depicting a study associated with therapeutic techniques as it pertains to embodiments of an intelligent training system.

FIG. 17 is a logical diagram showing an exemplary process associated with super diagnostics in accordance with aspects and embodiments of the present invention.

While the present invention may be embodied in many different forms, a number of illustrative embodiments are described next with reference to the above-described figures, with the understanding that the present disclosure is to be considered as providing examples of the principles of the invention and such examples are not intended to limit the invention to preferred embodiments described herein and/or illustrated herein.

### DETAILED DESCRIPTION OF THE PREFERRED EMBODIMENTS

In general, the word “engine” or “module” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

Each engine and module of the present invention may implement the techniques described herein using customized hard-wired logic, one or more ASICs or FPGAs, firmware and/or program logic which in combination with one or more computer system(s) causes or programs computer system to be a special-purpose machine. According to one embodiment, the techniques herein are performed by one or more computer system(s) in response to processor(s) executing one or more sequences of one or more instructions contained in main memory. Such instructions may be read into main memory from another storage medium, such as storage device. Execution of the sequences of instructions contained in main memory causes processor(s) to perform the process steps described herein. In alternative embodiments, hard-wired circuitry may be used in place of or in combination with software instructions.

As will be apparent to the skilled person, various engines and testing software discussed herein can be implemented on a number or arrangements of hardware devices and their associated operating systems—for example clusters, servers, computers, tablets, smartphones, etc. running any sufficiently powerful version of Windows, macOS, Linux, iOS, Android, etc., capable of executing processes described herein.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

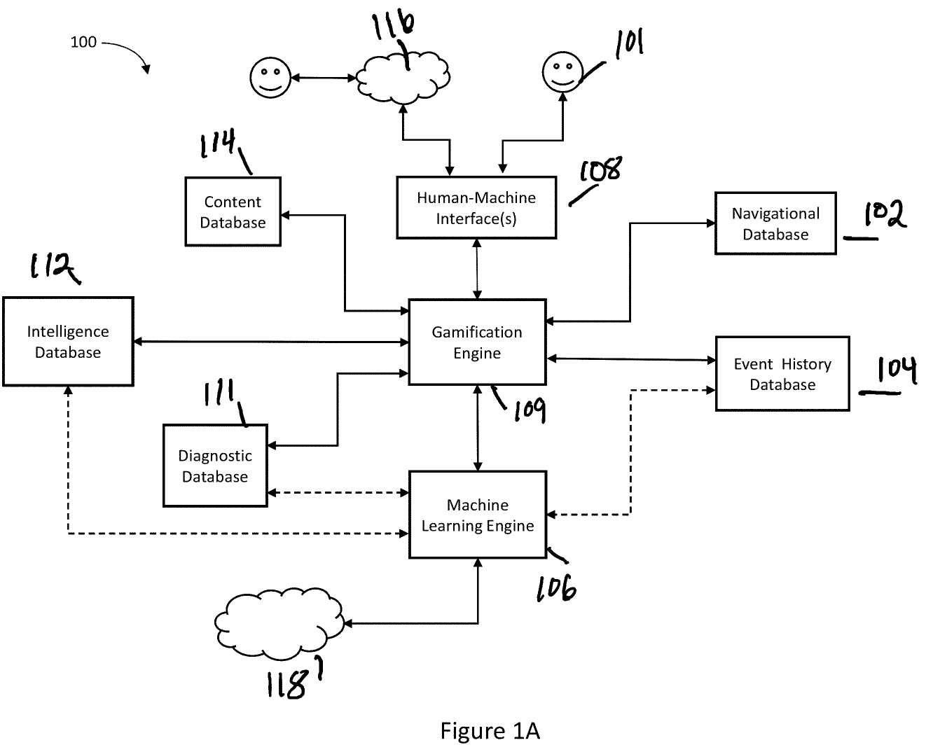

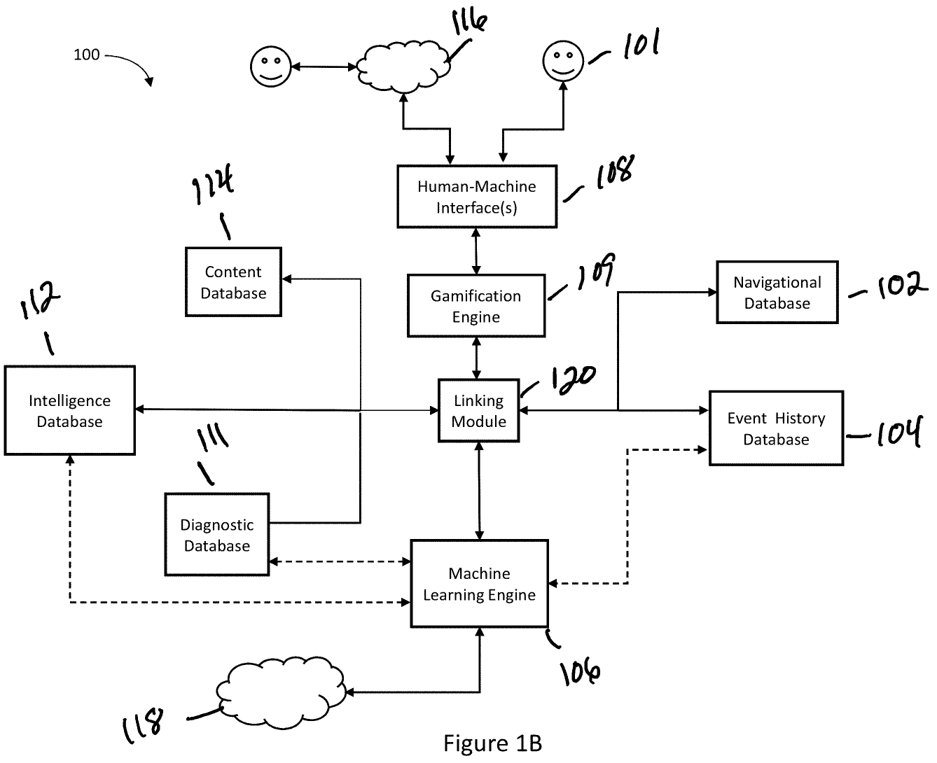

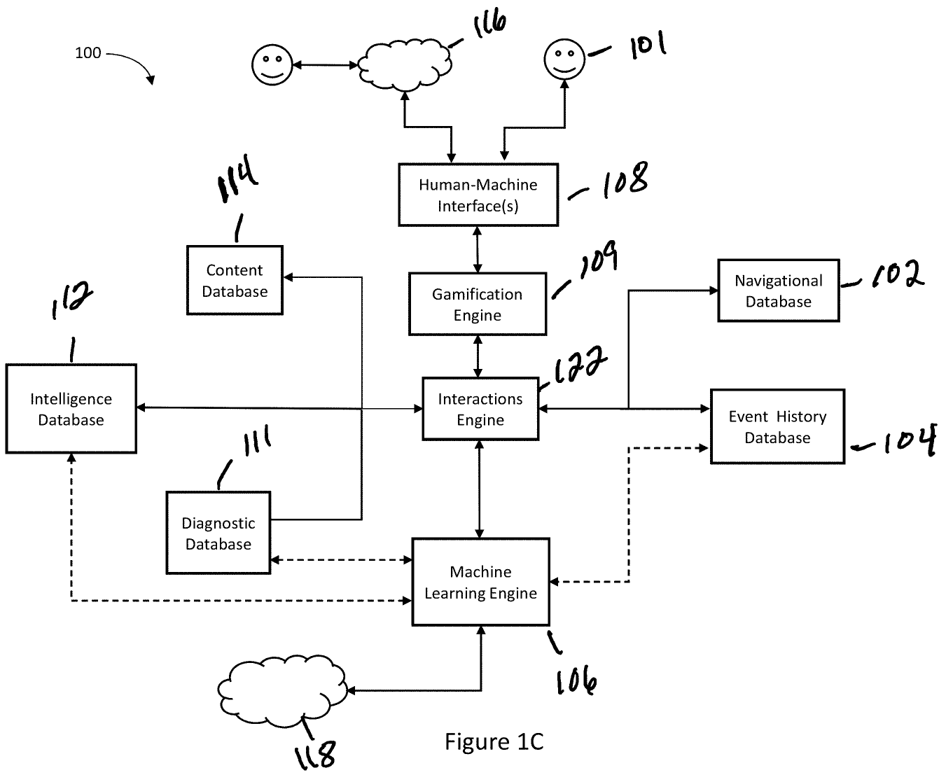

FIGS. 1A-1C, are block diagrams illustrating an intelligent training system (“system”, “claimed system”) in accordance with aspects, embodiments, and implementations of the present invention.

Referring to FIG. 1A, system 100 may include one or more human-machine interfaces 108 for interactive with a user 101. The system is preferably coupled with digital network 116, such as, but not limited to the Internet, LAN or WAN, to allow other users to remotely connect through other devices. System 100 may also include navigational database 102, event history database 104, machine learning engine 106, gamification engine 109, diagnostic database 111, intelligence database 112, content database 114 and egress network 118. These components are in electronic communication with each other as illustrated and configured to perform the various functions and processes described herein.

Content database 114 is for storing content data including free format text data. The gamification engine 109 is coupled to the content database and is for producing a gamified test interface including a first navigational path through at least one gamified representation of the free format text data. The at least one human-machine interface 108 coupled to the gamification engine 109 and is for presenting the gamified test interface and gathering test data. The intelligence database 112 is coupled to the gamification engine 109 for storing intelligence data including at least one semantic element associated with the free format text data. The diagnostic database 111 is coupled to the gamification engine 109 and is for storing diagnostic data.

According to certain embodiments, the gamification engine 109 further executes program code for querying the diagnostic database 111 to obtain the diagnostic data, comparing the test data to the diagnostic data, and generating at least one diagnostic result based on the comparison.

FIG. 1B presents another embodiment of the claimed system 100 wherein gamification engine 109, event history database 104, machine learning engine 106, diagnostic database 111, content database 114 and intelligence database 112 are communicatively coupled via linking module 120. As is described herein, the linking module 120 can be configured to communicatively couple or facilitate data communication between each of the engines 106, 109 and the databases 104, 106, 111, 112, 114.

FIG. 1C presents yet another embodiment of the claimed system 100 wherein an interactions engine 122 is incorporated and communicatively coupled to gamification engine 109, event history database 104, machine learning engine 106, diagnostic database 111, content database 114 and intelligence database 112. The interactions engine 122 can be configured to execute instructions for controlling data interactions between each of engines 109, 106; databases 104, 106, 109, 111, 112; or any of other engines, modules, or databases discussed in this document. For example, the interactions engine 122 could control the gamification engine 109 to delay a process for generating subsequent training content until the machine learning engine 106 or the intelligence database 112 has finished an interaction with the diagnostic database 111. Once the interactions engine 122 determines that the interaction is complete, it can allow the gamification engine 109 to proceed, thus potentially enabling the gamification engine 109 to draw upon newly updated information in the diagnostic database 111 and thereby improving the diagnostic quality of the subsequent training content.

The system and processes of the present invention are preferably implemented with artificial intelligence technology having machine learning. Exemplary technology is descrived in U.S. Pat. No. 5,701,400, the entire disclosure of which is incorporated by reference.

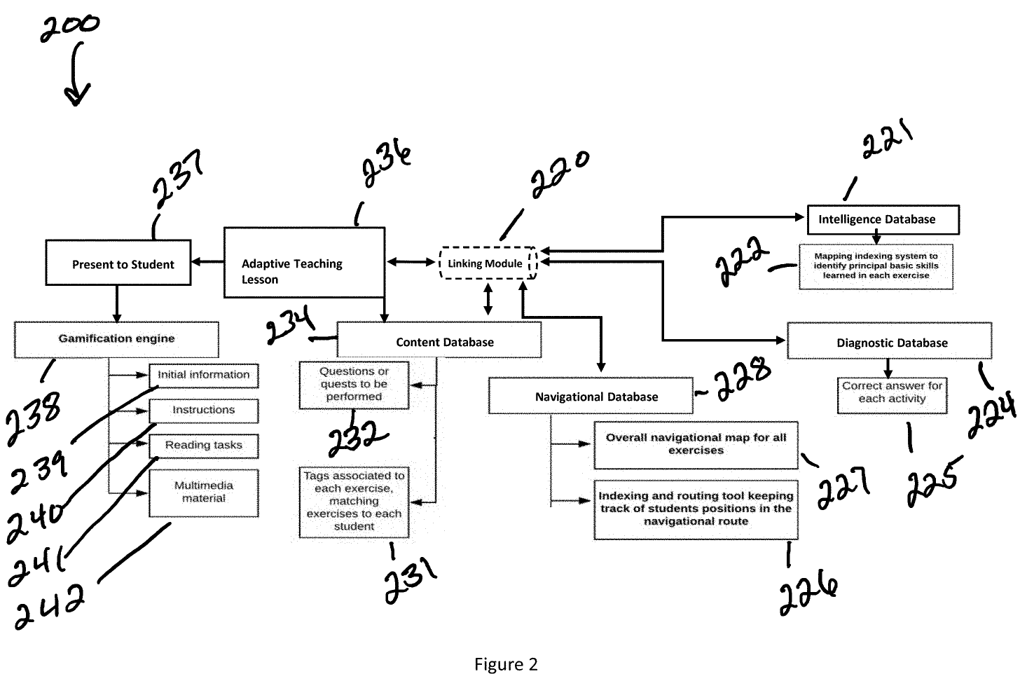

FIG. 2 is a logical block diagram according to an embodiment of the present invention, wherein adaptive teaching lesson 236 is presented to a student 237. The adaptive teaching lesson 236 comprises information 239-242 from gamification engine 238, information 231 and 232 from content database 234, information 226 and 227 from navigational database 228, information 222 from intelligence database 221 and information 225 from diagnostic database 224. Further shown in this embodiment is linking module 220 communicatively coupling adaptive teaching lesson 236 with content database 234, navigational database 228, intelligence database 221 and diagnostic database 224.

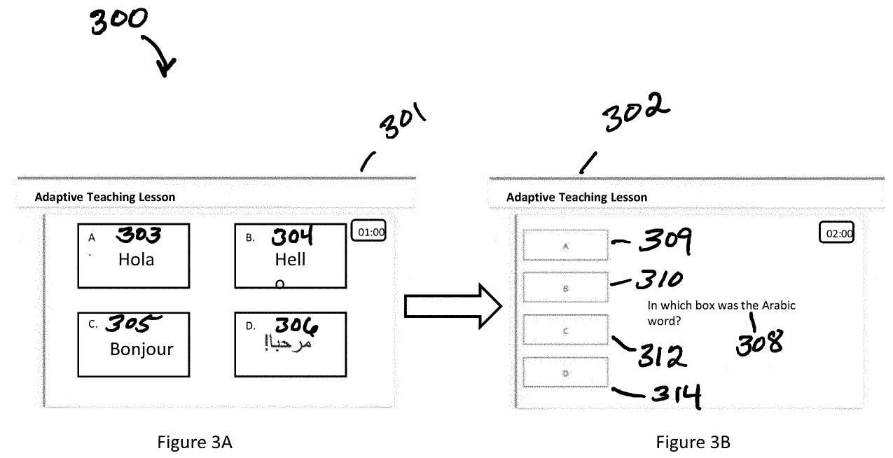

FIGS. 3A and 3B are exemplary interface screens 300 of a gamified interface associated with an embodiment of the claimed system 100, wherein a student (not shown) is presented a first interface 301 comprising boxes 303-306, each containing the word “hello” in a different language. In response to input from a user, a second interface 302 may then presented with question 308 and answer choices 309-314 pertaining to boxes 303-306. This is an example of basic navigation according to an aspect of the present invention.

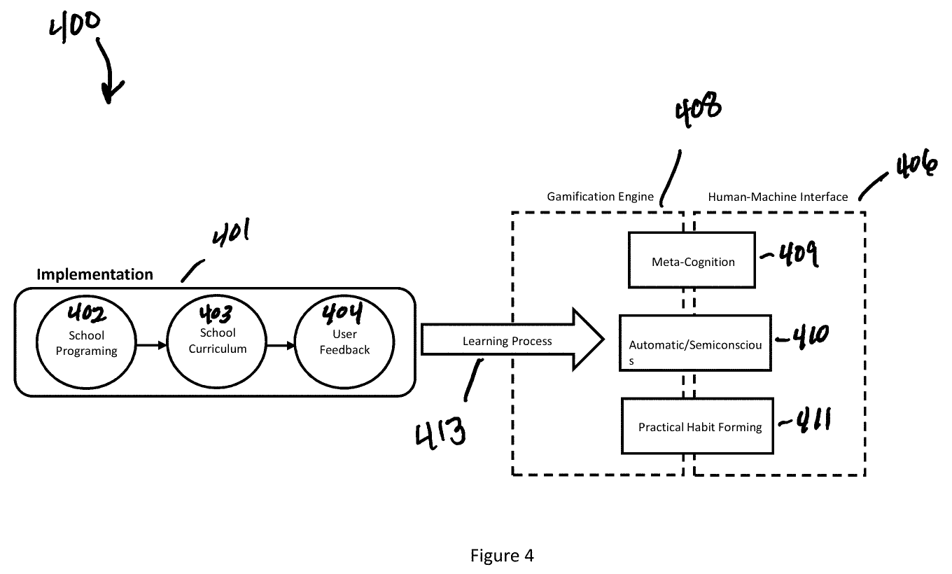

FIG. 4 is a flow diagram illustrating an example implementation 400 of a learning process 413 (e.g. training content) in accordance with the present learning system (e.g. system 100), Implementation 401 comprises components 402-404, which facilitate learning process 413 via gamification engine 408 and human machine interface 406. Learning process 413 includes techniques 409-411 which are realized, at least in part, by gamification engine 408 and human machine interface 406. Although techniques 409-411 are specifically illustrated, the techniques implemented by the gamification engine 408 can alternately or additionally include any of the educational techniques and strategies discussed herein.

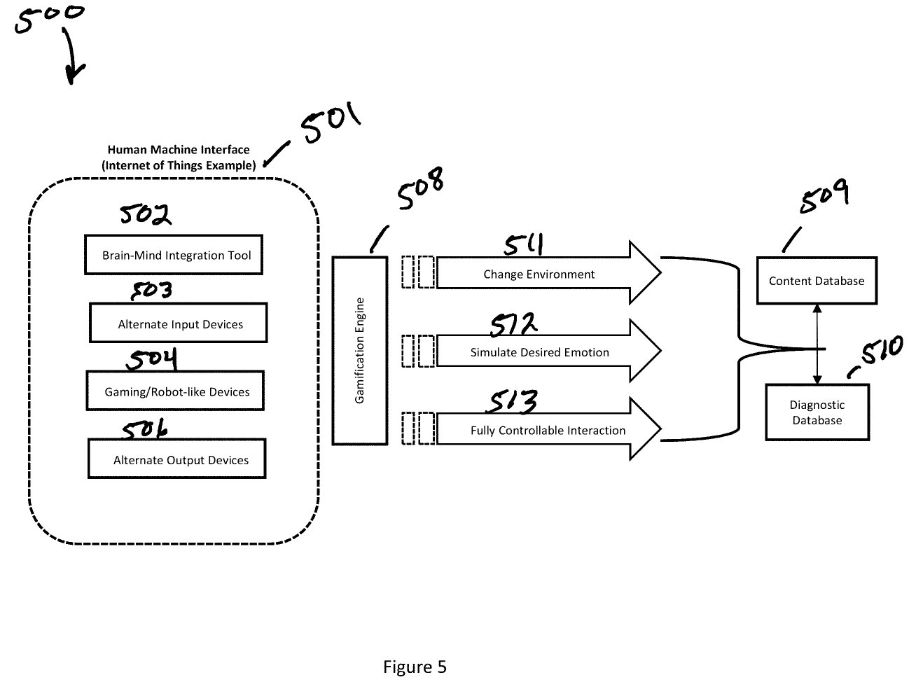

FIG. 5 is a diagram depicting one aspect 500 of an embodiment of the claimed training system 100 including a depiction of a human machine interface 501 having one or more interface modes (sub-interfaces) 502-505. Each interface mode 502-506 can comprise a device, such as an Internet of Things (IoT) device, smart device, or other human-machine interface examples discussed herein. Human machine interface 501 is communicatively coupled to gamification engine 508, content database 509, and diagnostic database 510. Further, via, at least in part, gamification engine 508, and using data received from human machine interface (HMI) 501 interface modes 502-506, one or more results 511-513 can be realized and subsequently stored in or otherwise associated with a content database 509 and/or diagnostic database 510.

Signals obtained in the data from human machine interface 501 sub-components may include an attentiveness index, a cognition index, heart rate, breathing rhythm data, corporal movements measurements, and other variables of mental and physical activity and temporary condition, so that different combinations of these variables allow the invention, after reading and processing their values, to improve the configuration of adaptive learning exercises for a particular individual at any particular time. Environmental effects and further alteration of their condition by mechanisms controlled by the invention, simulation of desired emotions and a fully controllable interaction are additional output the gamification engine 508 can provide for such improved learning experience. In the course of learning events such as user actions or screen displays, and through processing of the additional data coming from 501, the content database 509 and diagnostic database 510 store these output variables from the gamification engine 508.

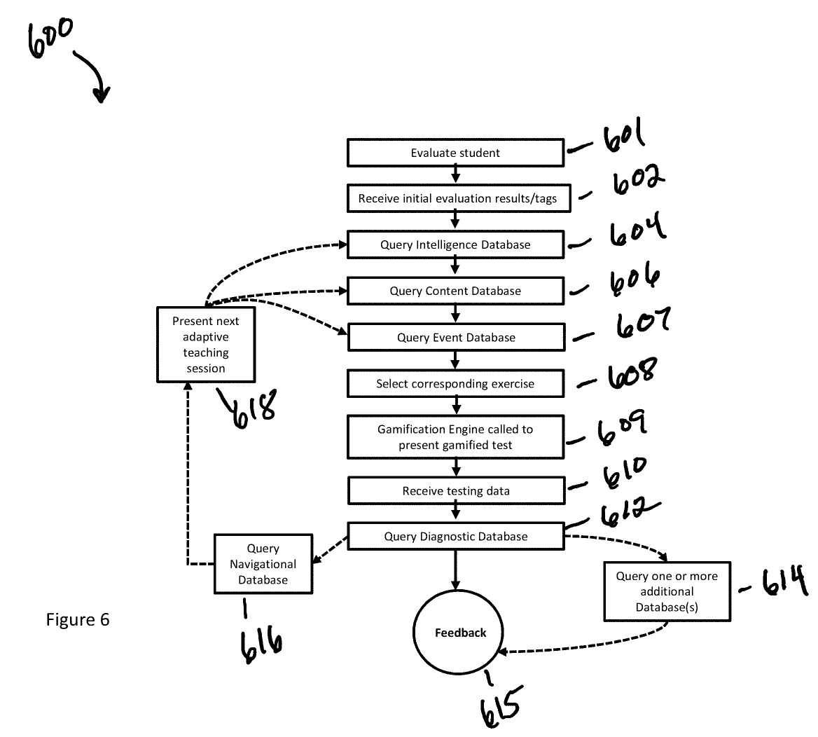

FIG. 6 is a flow chart representing a process 600 according to an embodiment of the present invention. It should be understood that the process 600 and the various steps 601-618, and variations thereof, is preferably implemented by embodiments of system 100 and its respectivce components, modules, engines (e.g. 106, 109, 122), and databases (e.g. databases 104, 111, 112, 114) described herein with reference to FIGS. 1A-C, and elsewhere, as applicable.

The process 600 begins with step 601 where the student is evaluated. The evaluation may performed using a human-machine interface as described herein using a navigation that may be preprogrammed or adaptive. The results of evaluation 601 are then received in step 602, including system tags for use in step 604 when the intelligence database is queried. Proceeding onto step 606, the content database is queried, followed by step 607 where the event database is queried. In response, in step 608 a corresponding exercise is selected and in step 609 the gamification engine is called to present a gamified test. In step 610 the testing data is received followed by step 612 where the diagnostic database is queried. Following step 612, the process can optionally proceed to step 615 where feedback is presented, or to step 614 to query one or more additional databases if there is insufficient information from which to proceed to step 615. Alternatively, rather than proceeding from step 612 to step 614 or 615, the system can query the navigational database as shown in step 616, present the next adaptive teaching session in step 618 and loop back to either step 604, 606 or 607.

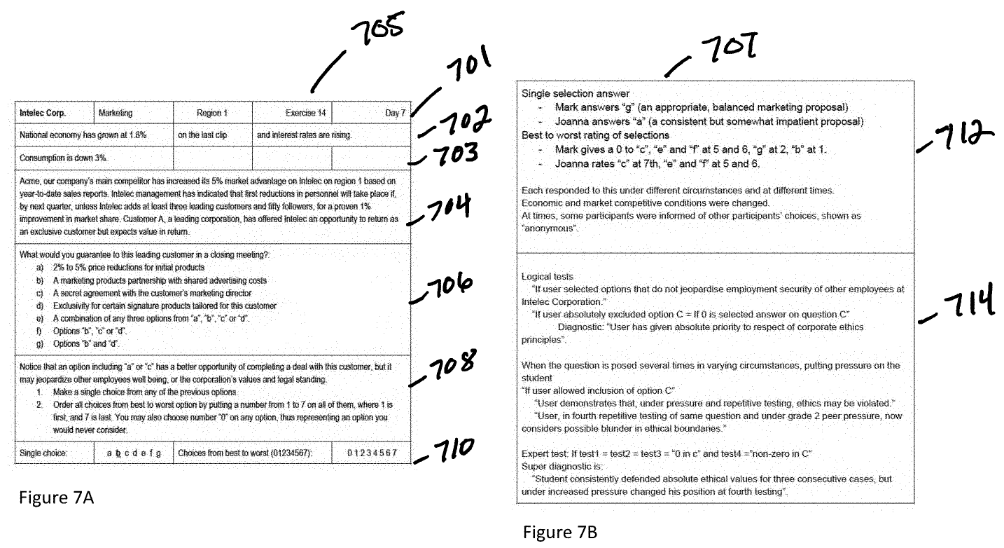

FIGS. 7A and 7B show examples of user interface screens 705, 707, as they might be seen by a student (not shown) interacting with an HMI 108 pursuant to an embodiment of a training system 100. Screen 705 includes row 701 comprising general identification information with respect to the subject and exercise. Rows 702 and 703 include information relating to the exercise being given. Row 704 provides a hypothetical scenario or problem used in the questions and answers row 706 where a specific question and various answer options are presented to the student. Row 708 provides additional instructions or context if necessary, and row 710 includes the students answer or answer combinations. Screen 707 is an example that might be viewed by an administrator or the like in order to help understand a student's answers and diagnosis, and includes rows 712 and 714 which display the student's answers and information necessary to understand how those answers correspond to the diagnosis.

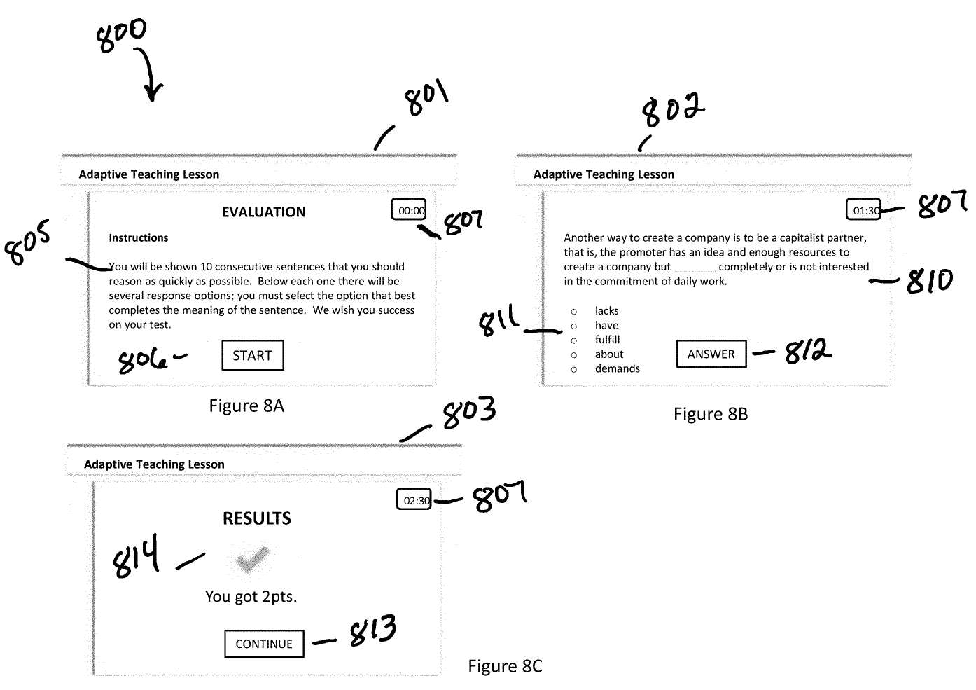

FIGS. 8A-8C show additional examples of user interface screens 801-803, as they might be seen by a student (not shown) interacting with an HMI 108 pursuant to an embodiment of a training system 100. More specifically, screen image 801 displays instructions 805 that explains the adaptive teaching session that a given student is about to take. Screen image 801 further comprises test counter 807 which keeps track of the duration of time spent on the adaptive teaching session, as well as user prompt 806, which can be selected to begin the adaptive teaching session. Screen image 802 shows test counter 807, test question 810, potential answers 811 and user prompt 812, which can be selected to submit the selected answer from potential answer set 811. Screen image 803 shows test counter 807, question answer results 814 and user prompt 813, which can be selected to move onto the next test question in the adaptive teaching session.

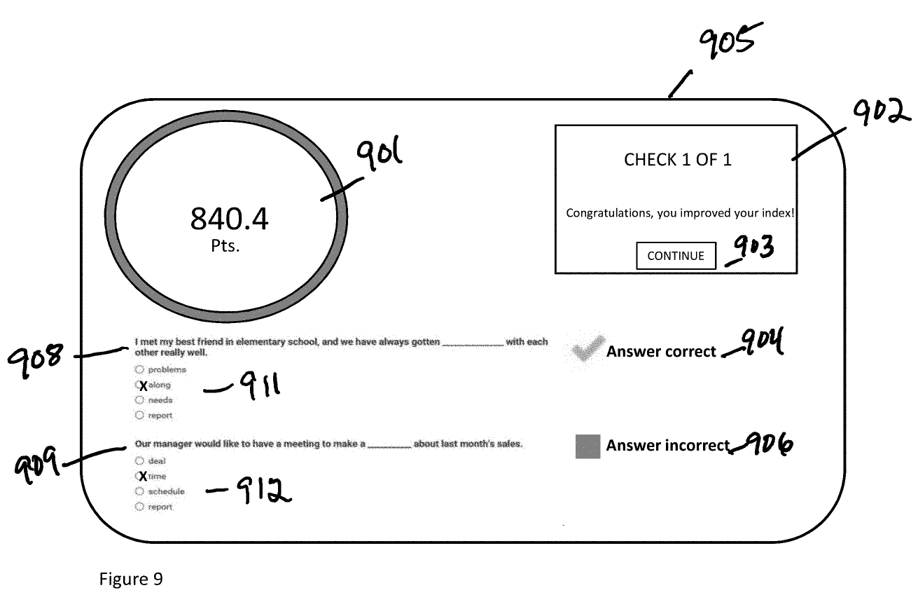

FIG. 9 shows an additional example of a user interface screen 905, as might be seen by a student (not shown) interacting with an HMI 108 pursuant to an embodiment of a training system 100. Screen image 905 represents a test summary screen that a student or administrator might be presented upon the completion of the adaptive learning session. Screen image 905 comprises overall points scored 901, informational box 912 with user prompt 903, questions answered 908-909, user's answers 911-912 and answer results 904-905, which indicate whether a response was correct or incorrect.

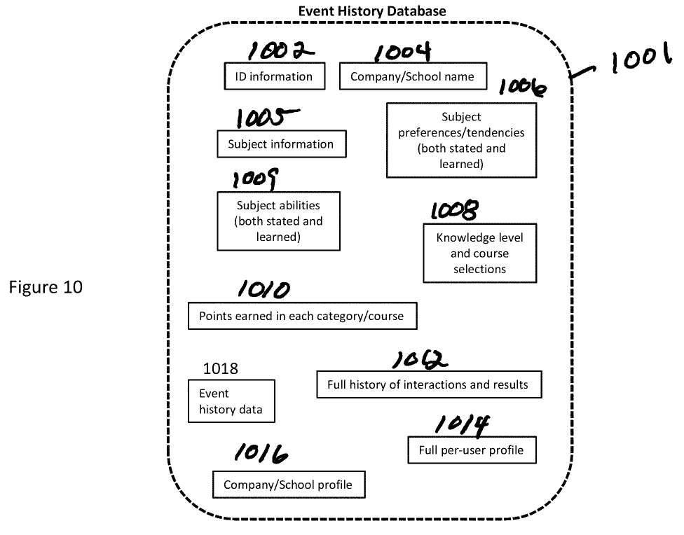

FIG. 10 is a logic diagram showing one embodiment of an event history database 1001, 104, which may comprise one or more pieces of information 1002-1018. The information stored in event history database 1001 may, more particularly, include ID information 1002, company or school name 1004, subject information 1005, subject preferences and/or tendencies 1006, subject abilities 1009, knowledge level and course 1008, points earned 1010, history of interactions 1012, company or school profile 1016 and/or per-user profile 1014. The event history database 1001 may also store additional types of event history data 1018 corresponding to any number or combination of the event history data, parameter, and element examples disclosed herein.

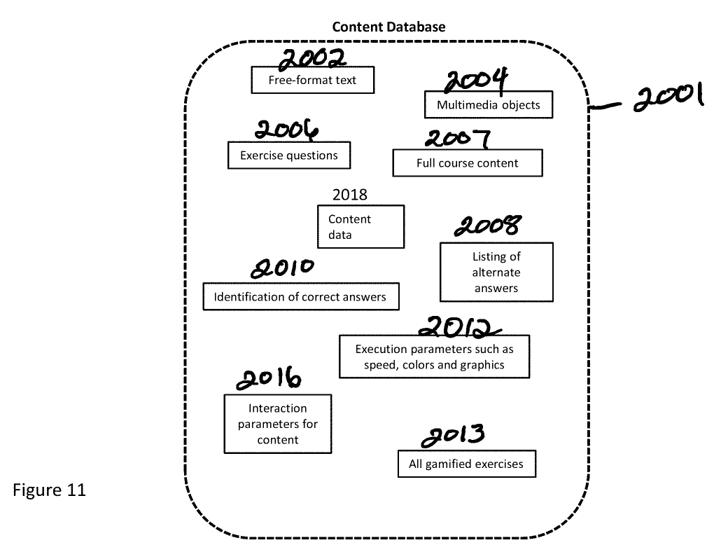

FIG. 11 is a logic diagram showing one embodiment a content database 2001, 114, which may comprise one or more pieces of information 2002-2018. The information stored in content database 2001 may, more particularly, include free-form text 2002, multimedia objects 2004, exercise questions 2006, full course content 2007, list of alternative answers 2008, identification of correct answers 2010, execution parameters 2012, interaction parameters 2016 and gamified exercises 2013. The content database 2001 may also store additional types of content data 2018 corresponding to any number or combination of the content data, parameter, and element examples disclosed herein.

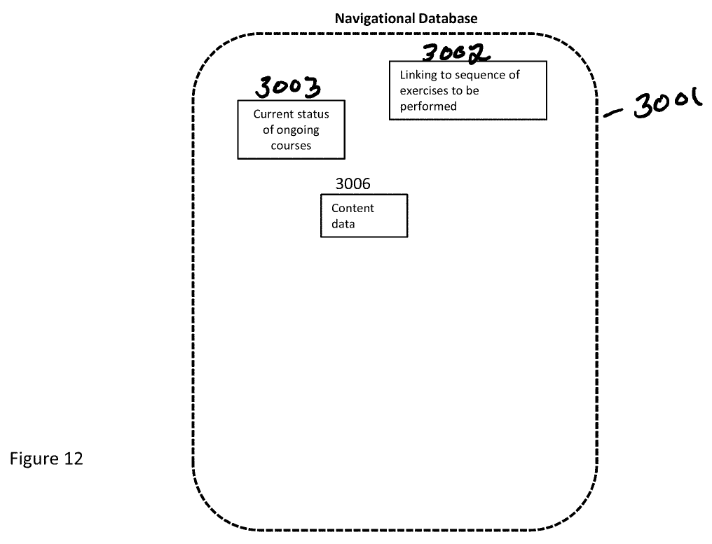

FIG. 12 is a logic diagram showing one embodiment of a navigational database 3001, 102, which may comprise one or more pieces of information 3002-3006. The information stored in navigational database 3001 may, more particularly, include linking to sequence of exercises 3002 and current status of on-going courses 3003. The navigational database 3001 may also store additional types of navigational data 3006 corresponding to any number or combination of the navigational data, parameter, and element examples disclosed herein.

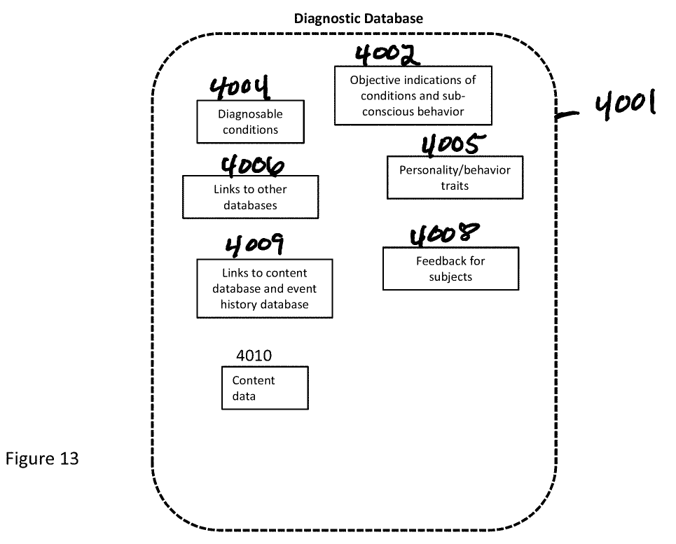

FIG. 13 is a logic diagram showing one embodiment of a diagnostic database 4001, 111, which may comprise one or more pieces of information 4002-4009. The information stored in diagnostic database 4001 may, more particularly, include objective indications of conditions and subconscious behavior 4002, diagnostic conditions 4004, personality/behavior traits 4005, links to other databases 4006, links to content database and event history database 4009, and feedback for subjects 4008. The diagnostic database 4001 may also store additional types of diagnostic data 4010 corresponding to any number or combination of the diagnostic data, parameter, and element examples disclosed herein.

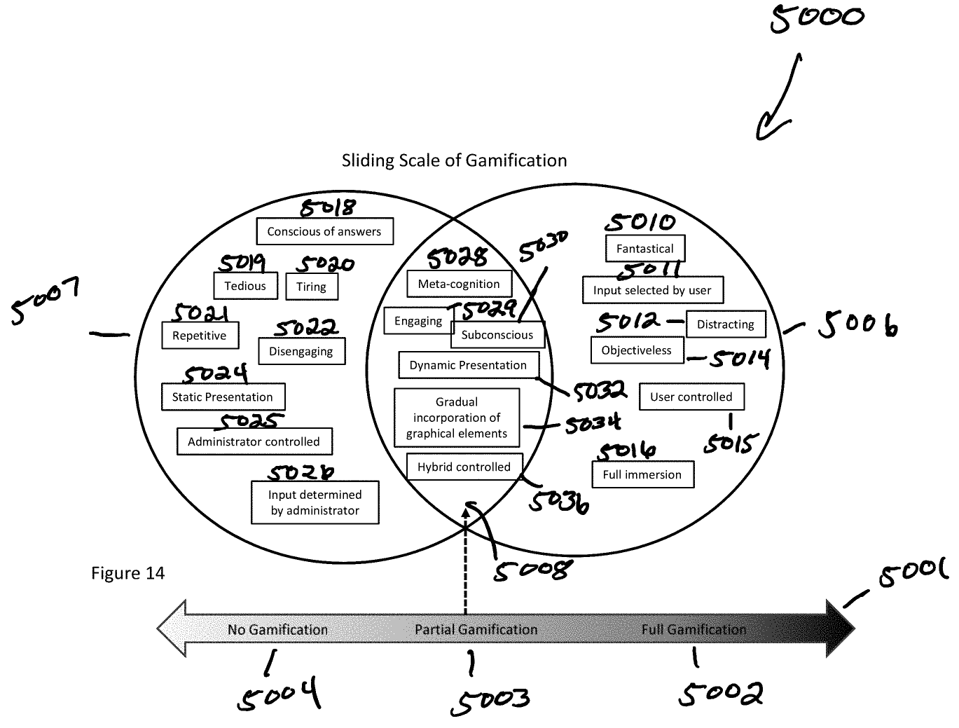

FIG. 14 is a logic diagram depicting a set 5000 of aspects pertaining to gamification as implemented, for example, in a training system 100. Specifically shown is a sliding scale of gamification 5001, having various aspects 5002-04 associated with various sections 5006, 5007, 5008, each including certain gamification properties/characteristics. Each segment and its respective gamification properties/characteristics are further associated with various training approaches (e.g. gamified training content presented via an HMI 108). One aspect 5004 is associated with properties having little to no gamification 5004, another aspect 5002 is associated with properties having full gamification 5002, and a third aspect 5003 positioned in between is associated with partial gamification 5003. The non-overlapping portion of section 5007 comprises properties 5018-5026 associated with little to no gamification 5004, the non-overlapping section of circle 5006 comprises properties 5010-5016 associated with with full gamification 5002, and overlapping section 5008 includes properties 5028-5036 associated with partial gamification 5003.

Sample characteristics of a non-gamified system such as 5004 may include conscious of answer 5018, tedious 5019, tiring 5020, repetitive 5021, disengaging 5022, static presentation 5024, administrator controlled 5025 and input determined by administrator 5026.

Exemplary elements of fully gamified 5002 may include fantastical 5010, input selected by user 5011, distracting 5012, objectiveless 5014, user controlled 5015, and full immersion 5016.

Exemplary elements of partially gamified 5003 may include meta-cognition 5028, engaging 5029, subconscious 5030, dynamic presentation 5032, gradual incorporation of graphical elements 5034, and hybrid controlled 5036.

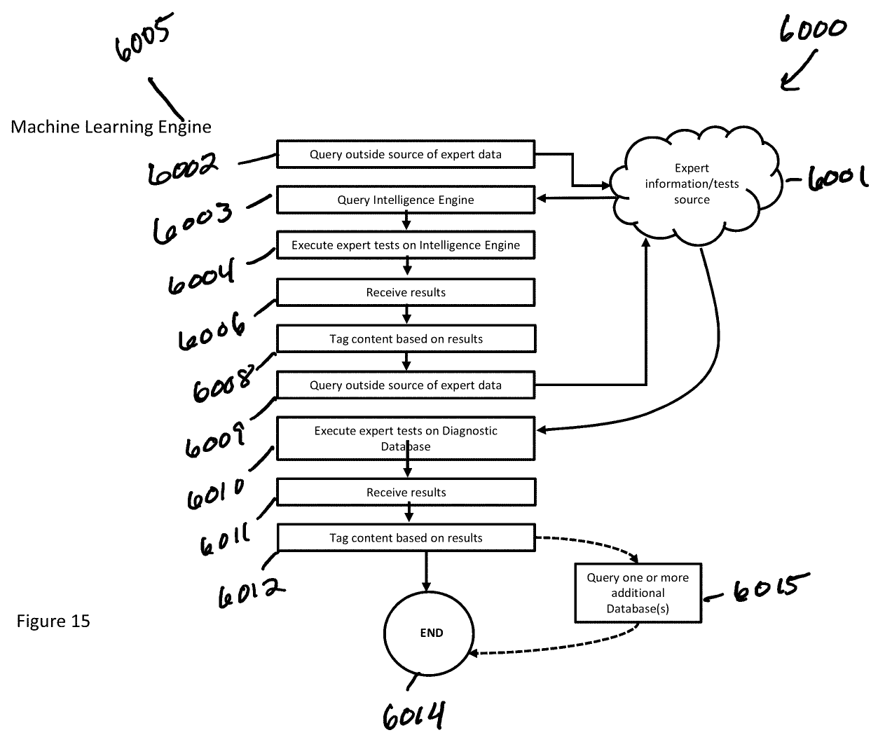

FIG. 15 is a flow diagram of a process 6000 employed by the machine learning engine 106, 6005 of the inventive system, according to embodiments of the present invention. Specifically, the flow of machine learning engine 6005 is shown with respect to its updating capability starting with step 6002 where an outside source of expert data/tests 6001 is queried. The intelligence engine is then queried in step 6003 followed by the execution of the expert tests/data on the intelligence engine in step 6004. The results are then received in step 6006 followed by the tagging of content based on the results in step 6008. In step 6009 outside data source 6001 is queried again and then in step 6010 the execution of the expert tests/data on the diagnostic database. In step 6011 the results of step 6010 are received and then the content is tagged based on the results in step 6012 and the process completes at step 6014. The flow can optionally move from step 6012 to step 6015 where one or more additional databases are queried at which point the process completes at step 6014. A machine learning engine 106 or other module of a training system 100 may iteratively perform successive reptitions of process 6000 pursuant to an iterative operation, for example an iterative operation associated with gamification, diagnostics, content, intelligence, (e.g. a machine learning algorithm; database restructuring/management; and the like).

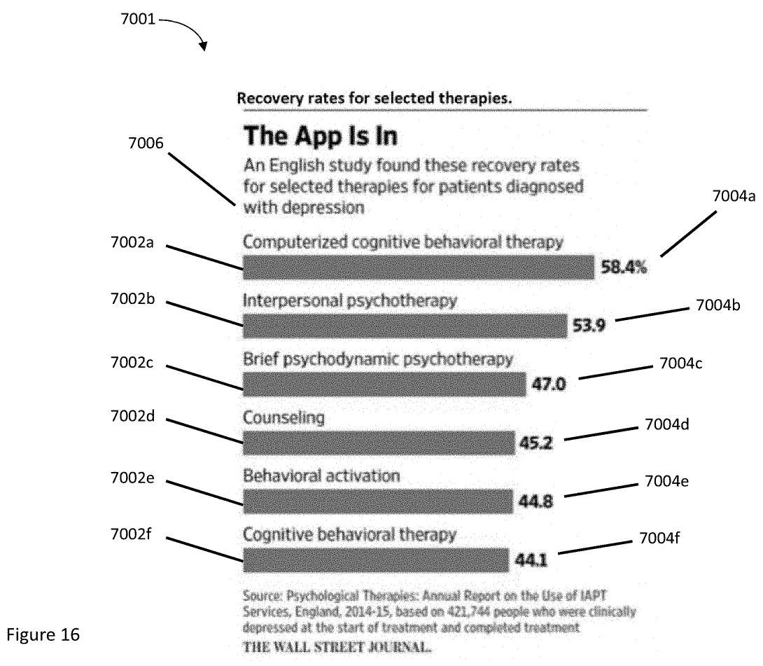

FIG. 16 is a diagram depicting an exemplary study 7001 of recovery rates 7004a-f associated with respective therapeutic techniques 7002a-f used on patients diagnosed with one or more conditions 7006 (e.g. a depression diagnosis). Computerized cognitive behavior therapy 7002a was associated with a 58.4% recovery rate 7004a. Interpersonal psychotherapy 7002b was associated with a 53.9% recovery rate 7004b. Brief psychodynamic psychotherapy 7002c was associated with a 47.0% recovery rate 7004c. Counseling 7002d was associated with a 45.2% recovery rate 7004d. Behavioral action 7002e was associated with a 44.8% recovery rate 7004e. And cognitive behavior therapy 7002f was associated with a 44.1% recovery rate 7004f.

The example 7001 in FIG. 16 illustrates how different therapeutic techniques 7002 can have different degrees of treatment effectiveness (e.g. recovery rates) 7004 for a given condition or set of conditions 7006. It is to be understood that in the context of this invention, diagnostic data stored in a diagnostic database (e.g. 111, 4001) can include or otherwise be associated with conditions 7006, treatment effectiveness parameters 7004, and techniques 7002. Conditions 7006, treatment effectiveness parameters 7004, and therapeutic techniques 7006, can each further correspond to any of the diagnostic information 4002-4009, or diagnostic parameters and related diagnostic parameters discussed herein. Thus, knowledge that certain treatment techniques are more effective for certain conditions can generally be applied to the intelligence of the system and used to optimize the selection of gamified training content.

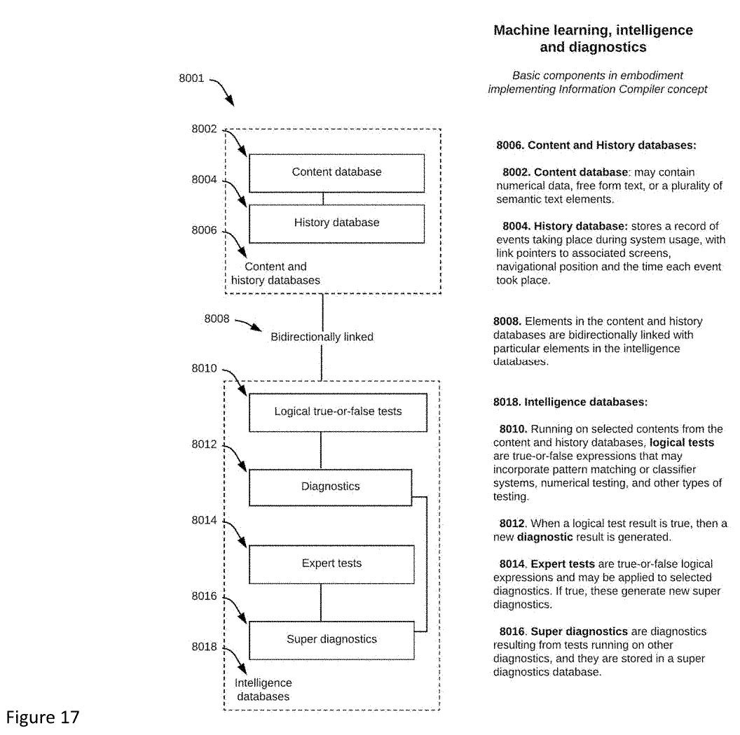

FIG. 17 is a logical diagram depicting an exemplary set of structural and functional aspects 8001 associated with a machine learning engine 106 or intelligence database 112 in an embodiment of an intelligent training system 100. The various aspects 8002-8018 describe various structural elements and/or associated functionality for identifying and storing diagnostics or super diagnostics based on logical and expert tests (e.g. machine learning algorithms or other database operations described herein), as can be implemented in various aspects of a system such as the adaptive training system 100 depicted in FIGS. 1A-1C.

A first group of aspects corresponds to content and history database aspects 8006, and a second group of aspects corresponds to intelligence database aspects 8018. Within the first group 8006, a content database 8002 may contain numerical data, or free form text database, or a plurality of semantic text elements which may be organized in a semantic, interconnected network structure. A history database 8004 containing a record of events taking place during usage of the invention, with link pointers of other means to link to associated screens, position in navigational paths, and a time-stamp for all or selected events.

Within the second group 8018, logical tests 8010 or “analysis rules”, represent true-or-false logical expressions running on selected content in the content database, and may incorporate pattern matching or classifier systems, numerical testing through formula expressions, or other types of testing. These tests are capable of running on selected contents from the content and history databases. When their result is true, logical tests generate new diagnostic results. Any logical test may contain a unique identifier code, an associated pre-defined diagnostic such as a message and, if the test turns true and a new diagnostic is generated, information about link elements such as bidirectional links to any associated data content. There can also be links to functional program code updating navigation paths, or screens, or acting on devices of any kind, for actions are to be performed if the diagnostic turns true. Diagnostic results 8012 (“diagnostic statements”) may be stored in a diagnostic database. Expert tests 8014 are true-or-false logical expressions and may be applied to selected content from the diagnostics database. If true, these generate new super diagnostics 8016, to be stored in a super diagnostics database.

One or more of the databases, engines, or modules discussed herein, may further store and/or execute definitions stating on which contents in the content and history databases 8002 will logical tests or “analysis rules” 8010 be run, and on which specific contents in the diagnostic database 8012 will expert tests 8014 run. Fuzzy logic values (or formula expressions) may be associated to any particular test 8010 or 8014, so that a fuzzy logic value is stored, associated with its resulting diagnostic 8012. Then, other Fuzzy logic formulas to be applied on fuzzy logic values associated with diagnostics 8012 may be used for the generation of super diagnostics 8016.

In one possible implementation, fuzzy logic uses probabilistic values as variables or parameters, and diagnostics 8012 and super diagnostics 8016 would then have associated probabilities or relevance index values applicable in different measures to different users that may consult the diagnostic and super diagnostics databases. Particular contents of the diagnostic database 8012 are bidirectionally linked 8008 or associated with particular elements of said data databases through the use of link pointers or other means. For example, when a logical test runs 8010 on particular content, if the logical test 8010 turns true and generates a new diagnostic 8012, this diagnostic 8012 may be bi-directionally linked to the particular content 8002 so tested. In a similar manner, particular contents of the super diagnostic 8016 database may be bi-directionally linked 8008 or associated with particular contents of the diagnostic 8012 databases. Diagnostics 8012 and super diagnostics 8016, logical true-or-false tests 8010 and expert tests 8014, may be stored in an integrated intelligence database 8018.

Any logical tests 8010 or any expert test 8014 may make use, within its expression, of any pattern matching or classification algorithm(s) known in the machine learning and artificial intelligence fields. This complete implementation executes as a content information compiler, by creating an intelligence database 8018 parallel to content 8006, like a different dimension and interpretation of the same data, interconnecting selected elements by bidirectional links 8008 allowing for certain types of Organic Knowledge collaboration. And, multiple runs of expert tests generating new levels of super diagnostics may work as an equivalent to multiple levels in a Gestalt-Multiplex-Layering (GML) system.

Having described above several aspects of at least one implementation, it is to be appreciated various alterations, modifications, and improvements will readily occur to those skilled in the art. Such alterations, modifications, and improvements are intended to be part of this disclosure and are intended to be within the scope of the description. Accordingly, the foregoing description and drawings are by way of example only, and the scope of the disclosure should be determined from proper construction of the appended claims, and their equivalents.

We claim:

1. An adaptive teaching system, comprising:
a content database for storing content data including free format text data;
a gamification engine coupled to the content database, the gamification engine for producing a gamified text;
a machine learning engine coupled to the gamification engine for executing machine learning program code;
at least one human-machine interface coupled to the gamification engine, the at least one human-machine interface for presenting the gamified text interface and gathering text data;
a diagnostic database coupled to the gamification engine for storing diagnostic data; and
the machine learning engine executing the machine learning program code for:
querying the diagnostic database to obtain the diagnostic data;
comparing the text data to the diagnostic data; and
generating at least one diagnostic result based on the comparison.

2. The adaptive teaching system of claim 1, further comprising an intelligence database coupled to the gamification engine for storing intelligence data.

3. The adaptive teaching system of claim 2, wherein the intelligence data includes at least one semantic element associated with the free format text data.

4. The adaptive teaching system of claim 1, wherein the gamified text interface includes a first navigational path through at least one gamified representation of the free format text data.

5. The adaptive teaching system of claim 4, wherein the gamification engine is further configured for creating, based on the at least one diagnostic result, an updated gamified text interface including a second navigational path through at least one gamified representation of the free format text data.

6. The adaptive teaching system of claim 1, wherein the diagnostic result is provided to the gamification engine as feedback and used to generate an additional gamified text interface

7. The adaptive teaching system of claim 1, wherein the gamification engine associates the diagnostic result with a user and in response generates an additional gamified text interface for presenting a treatment to the user via the human-machine interface.

8. The adaptive teaching system of claim 1, wherein the machine learning program code is further configured for:
calling at least one machine learning algorithm for analyzing diagnostic patterns;
evaluating the diagnostic database via the at least one machine learning algorithm;
generating at least one modification suggestion in response to evaluating; and
modifying the diagnostic database based on said modification suggestion.

9. The adaptive teaching system of claim 1, further comprising an event history database for storing event history data based on previous interactions with gamified text interfaces via human-machine interfaces.

10. The adaptive teaching system of claim 8, wherein in evaluating the diagnostic database, the machine learning program code identifies at least one diagnostic parameter associated with second free format text data stored in the event history database.

11. The adaptive teaching system of claim 8, wherein in evaluating the diagnostic database, the machine learning program code identifies at least one diagnostic parameter associated with training data, the training data stored an external database accessed via a remote API.

12. The adaptive teaching system of claim 8, wherein the gamification engine further executes program code for:
comparing the modified diagnostic database to the intelligence database; and
modifying the at least one semantic parameter in the intelligence database based on the comparison.

13. The adaptive teaching system of claim 1, wherein the comparing further includes comparing the text data to the event history data.

14. The adaptive teaching system of claim 1, wherein the gamification engine is configured to iteratively create updated gamified text interfaces having respective additional navigational paths through respective additional gamified representations of the free format text data in response to progressively receiving new diagnostic results based on new text data.

15. The adaptive teaching system of claim 5, wherein creating the updated gamified text interface is further based on information received from either the event history database or the navigational database.

16. The adaptive teaching system of claim 5, wherein the updated gamified text interface includes a treatment instructing a user to take a remedial action.

17. The adaptive teaching system of claim 16, wherein the treatment is further provided in response to the gamification engine calculating that the diagnostic result matches a user to a sufficient degree of accuracy.

18. The adaptive teaching system of claim 17, wherein in calculating the degree of accuracy, the gamification engine identifies at least one super diagnostic associated with the diagnostic result.

19. The adaptive teaching system of claim 18, wherein the super diagnostic is identified at least in part based on fuzzy logic.

20. The adaptive teaching system of claim 5, wherein the updated gamified text interface includes a query instructing a user to provide additional text data via the human-machine interface.

21. The adaptive teaching system of claim 1, wherein the at least one gamified representation of the free format text data includes at least one gami-animation element.

22. The adaptive teaching system of claim 1, wherein the human-machine interface includes at least one of a virtual reality interface, augmented reality interface, robot or robot-like device, holographic projector, wearable device, kinetic device, brain-computer interface, tactile interface, olfactory interface, or taste interface.

23. The adaptive teaching system of claim 1, wherein in producing the gamified text interface, the gamification engine associates the free format text data with at least one of a question, treatment, lesson, chapter, or program.

24. The adaptive teaching system of claim 1, wherein in producing the gamified text interface, the gamification engine associates the free format text data with at least one of a user or a condition.

25. The adaptive teaching system of claim 1, wherein the event history database includes at least one link or pointer referencing the intelligence database for associating the event history data with the free format text data.

26. The adaptive teaching system of claim 1, wherein the intelligence database includes at least one link or pointer referencing the diagnostic database for associating the free format text data with the diagnostic data.

27. The adaptive teaching system of claim 1, wherein at least one of the machine learning engine is further configured for modifying the intelligence database based on the diagnostic data.

28. The adaptive teaching system of claim 1, wherein the gamification engine is further configured for providing a therapeutic response only when a diagnostic result is determined with a sufficient degree of accuracy.

29. The adaptive teaching system of claim 1, wherein the gamification engine further determines the degree of accuracy based on at least one super diagnostic associated with the diagnostic result.

30. The adaptive teaching system of claim 28, wherein the determination of the degree of accuracy is further determined at least in part based on fuzzy logic.

31. An adaptive teaching system, comprising:
a content database for storing content data including free format text data;
a gamification engine coupled to the content database, the gamification engine for producing a gamified text interface;
at least one human-machine interface coupled to the gamification engine, the human-machine interface for presenting the gamified text interface and gathering text data;
an event history database coupled to the gamification engine for storing event history data;
a diagnostic database coupled to the gamification engine for storing diagnostic data;
an intelligence database coupled to the gamification engine for storing intelligence data;
a machine learning engine coupled to the gamification engine, wherein the machine learning engine executes machine learning program code for:
calling a machine learning algorithm;
comparing the diagnostic data to at least one of the event history data, the text data, or the intelligence data via the machine learning algorithm;
determining, based on the comparison, at least one diagnostic association between the diagnostic data and the at least one of the event history data, the text data, the content data, the intelligence data, or external data from a remote database; and modifying the diagnostic database based on the diagnostic association.

32. The adaptive teaching system of claim 31, wherein the at least one gamified representation of the free format text data includes at least one gami-animation element.

33. The adaptive teaching system of claim 31, wherein the human-machine interface includes at least one of a virtual reality interface, augmented reality interface, robot or robot-like device, holographic projector, wearable device, kinetic device, brain-computer interface, tactile interface, olfactory interface, or taste interface.

34. The adaptive teaching system of claim 31, wherein in producing the gamified text interface, the gamification engine associates the free format text data with at least one of a question, treatment, lesson, chapter, or program.

35. The adaptive teaching system of claim 31, wherein in producing the gamified text interface, the gamification engine associates the free format text data with at least one of a user or a condition.

36. The adaptive teaching system of claim 31, wherein the event history database includes at least one link or pointer referencing the intelligence database for associating the event history data with the free format text data.

37. The adaptive teaching system of claim 31, wherein the intelligence database includes at least one link or pointer referencing the diagnostic database for associating the free format text data with the diagnostic data.

38. The adaptive teaching system of claim 31, wherein at least one of the machine learning engine is further configured for modifying the intelligence database based on the diagnostic data.

39. The adaptive teaching system of claim 31, wherein the gamification engine is further configured for providing a therapeutic response only when a diagnostic result is determined with a sufficient degree of accuracy.

40. The adaptive teaching system of claim 31, wherein the gamification engine further determines the degree of accuracy based on at least one super diagnostic associated with the diagnostic result.
